(19) United States
(12) Patent Application Publication
(10) Pub. No.: US 2011/0191404 A1
(43) Pub. Date: Aug. 4, 2011

(54) DELIVERY SYSTEM, AGENT SERVER, AND DELIVERY METHOD

(75) Inventor: Masaharu Kako, Osaka (JP)

(73) Assignee: FUJITSU LIMITED, Kawasaki-shi (JP)

(21) Appl. No.: 13/085,943

(22) Filed: Apr. 13, 2011

Related U.S. Application Data
(63) Continuation of application No. PCT/JP2008/069688, filed on Oct. 29, 2008.

(51) Int. Cl. G06F 15/16

(52) U.S. Cl. 709/202

(57) ABSTRACT

An SIP server determines whether the number of increased audiences is a switching from unicast to multicast “(U2M) threshold value”, stored in a connection threshold value storing unit, or more in a case where a viewing request is received from a viewing device and determines whether the number of decreased audiences is less than an “M2U threshold value” when a viewing end is received from a viewing device. As a result, multicast transmission is controlled to be performed in a case where the number of delivery requests is determined to be the “U2M threshold value” or more, and unicast transmission is controlled to be performed in a case where the number of delivery requests is less than the “M2U threshold value”.

### CROSS-REFERENCE TO RELATED APPLICATION

This application is a continuation of International Application No. PCT/JP2008/069688, filed on Oct. 29, 2008, the entire contents of which are incorporated herein by reference.

### FIELD

The embodiments discussed herein are directed to a delivery system, an agent server, and a delivery method capable of delivering contents to a terminal.

### BACKGROUND

From the past, a technology has been known in which a server (for example, a content folder or a key station) as a delivery source for content delivery, delivers contents to a plurality of terminals (for example, audience terminals). For example, as a content delivery technology, contents are multicast through an internet protocol television (IPTV) broadcast (for example, see Japanese Laid-open Patent Publication No. 2007-068129).

In the IPTV broadcast, a communication path is set up between a content folder and an audience terminal, and multicast delivery of contents is performed along the path that has been set up (see Japanese Laid-open Patent Publication No. 2002-064558). In addition, in such multicast delivery, a technology is used in which delivery is stopped in a case where an audience terminal as a reception side is not present (see Japanese Laid-open Patent Publication No. 2004-228968).

However, according to the above-described contents delivery technology, a packet is transmitted by way of multicast delivery even in a case where the number of audiences is small. Accordingly, there occurs an event in which unnecessary packets occupy the communication band within a relay network, and therefore there is a problem in that the quality of the communication service is degraded.

### SUMMARY

According to an aspect of an embodiment, a delivery system includes a delivery server that delivers delivery information to a delivery zone to which a plurality of terminals belongs; a relay server that relays the delivery information between the delivery zones; and an agent server that controls the relay server so as to perform a relay operation between the delivery zones. The agent server includes an audience number determining unit that determines whether or not the number of delivery requests, which are used to request for delivery, from the terminals located within the delivery zone is a predetermined threshold value or more; and a transmission control unit that controls the delivery server and/or the relay server so as to perform multicast transmission in a case where the number of the delivery requests is determined to be the predetermined threshold value or more by the audience number determining unit and controls the delivery server and/or the relay server so as to perform unicast transmission in a case where the number of the delivery requests is determined to be less than the predetermined threshold value by the audience number determining unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is an example of the configuration of a network that relays IPTV broadcast;

FIG. 2 is an example of forming a multicast delivery path;

FIG. 3 is a block diagram illustrating the configuration of an SIP server according to a first embodiment;

FIG. 4 is an example of the data configuration of a viewing request;

FIG. 5 is an example of the data configuration of a response #U to a viewing request;

FIG. 6 is an example of the data configuration of a response #M to a viewing request;

FIG. 7 is an example of the data configuration of a viewing port change #U;

FIG. 8 is an example of the data configuration of a viewing port change #M;

FIG. 9 is an example of the data configuration of a response to a viewing port change #U;

FIG. 10 is an example of the data configuration of a response to a viewing port change #M;

FIG. 11 is an example of the data configuration of viewing end;

FIG. 12 is an example of the data configuration of viewing end;

FIG. 13 is a diagram illustrating an example of the data configuration of content delivery managing information;

FIG. 14 is a diagram illustrating an example of a connection threshold value;

FIG. 15 is a diagram illustrating an example of a multicast-reaching-zone address list;

FIG. 16 is a diagram illustrating a transition of a transmission destination address converting table;

FIG. 17 is a diagram illustrating a transition of a transmission destination address converting table;

FIG. 18 is a diagram illustrating a transition of a transmission destination address converting table;

FIG. 19 is a diagram illustrating a transition of a transmission destination address converting table;

FIG. 20 is a diagram illustrating a transition of a transmission destination address converting table;

FIG. 21 is a diagram illustrating a transition of a transmission destination address converting table;

FIG. 22 is a diagram illustrating an example of a connection between multicast domains through a boundary device;

FIG. 23 is a diagram illustrating an example of a connection between multicast domains through a boundary device;

FIG. 24 is a diagram illustrating an example of a connection between multicast domains through a boundary device;

FIG. 25 is a diagram illustrating a sequence of forming a multicast path between an audience and a content folder when the first audience issues a viewing request;

FIG. 26 is a diagram illustrating a sequence of forming a multicast path between an audience and a content folder when the audience issues a viewing request in a state in which another audience is already receiving the broadcast contents from the desired content folder;

FIG. 27 is a diagram illustrating a sequence of a change from unicast to multicast in a case where it is determined that multicast delivery reduces the network traffic more than unicast delivery due to an increase in the number of audiences within a multicast domain;

FIG. 28 is a diagram illustrating a sequence of a change from multicast to unicast in a case where it is determined that unicast delivery reduces the network traffic more than multicast delivery due to a decrease in the number of audiences within a multicast domain;

FIG. 29 is a diagram illustrating a sequence of a change from unicast to multicast in a case where it is determined that multicast delivery reduces the network traffic more than unicast delivery due to an increase in the number of audiences present out of the multicast domain;

FIG. 30 is a diagram illustrating a sequence of a change from multicast to unicast in a case where it is determined that unicast delivery reduces the network traffic more than multicast delivery due to a decrease in the number of audiences present out of the multicast domain;

FIG. 31 is a sequence diagram in a case where a content folder is notified of a viewing end in a case where the last audience is an audience present within the multicast domain;

FIG. 32 is a sequence diagram in a case where a content folder is notified of a viewing end in a case where the last audience is an audience present within the multicast domain;

FIG. 33 is a flowchart illustrating the operation of a relay process of a viewing request in an SIP server 10 according to the first embodiment;

FIG. 34 is a flowchart illustrating the operation of a relay process of a response to a viewing request in an SIP server 10 according to the first embodiment;

FIG. 35 is a flowchart illustrating the operation of a reception process of a response to a viewing port change in an SIP server 10 according to the first embodiment;

FIG. 36 is a flowchart illustrating the operation of a relay process of a viewing end in an SIP server 10 according to the first embodiment;

FIG. 37 is a flowchart illustrating the operation of a reception process of a viewing end in an SIP server 10 according to the first embodiment;

FIG. 38 is a flowchart illustrating the operation of a relay process of a viewing request in an SIP server 10 according to the first embodiment;

FIG. 39 is a flowchart illustrating the operation of a relay process of a response to a viewing request in an SIP server 10 according to the first embodiment;

FIG. 40 is a flowchart illustrating the operation of a relay process of a viewing end in an SIP server 10 according to the first embodiment;

FIG. 41 is a flowchart illustrating the operation of a reception process of a viewing port change in an SIP server 10 according to the first embodiment;

FIG. 42 is a flowchart illustrating the operation of a transmission process of a viewing start request in a viewing device 40 according to the first embodiment;

FIG. 43 is a flowchart illustrating the operation of a reception process of a response to a viewing request in a viewing device 40 according to the first embodiment;

FIG. 44 is a flowchart illustrating the operation of a reception process of a viewing port change in a viewing device 40 according to the first embodiment; and

FIG. 45 is a flowchart illustrating the operation of a relay process of a viewing end in a viewing device 40 according to the first embodiment.

### DESCRIPTION OF EMBODIMENTS

Preferred embodiments of the present invention will be explained with reference to accompanying drawings.

### [a] First Embodiment

In the following embodiment, the configurations and the process flows of a content delivery system and an SIP server according to a first embodiment will be sequentially described, and the advantages according to the first embodiment will be described in the end.

Configuration of SIP Server

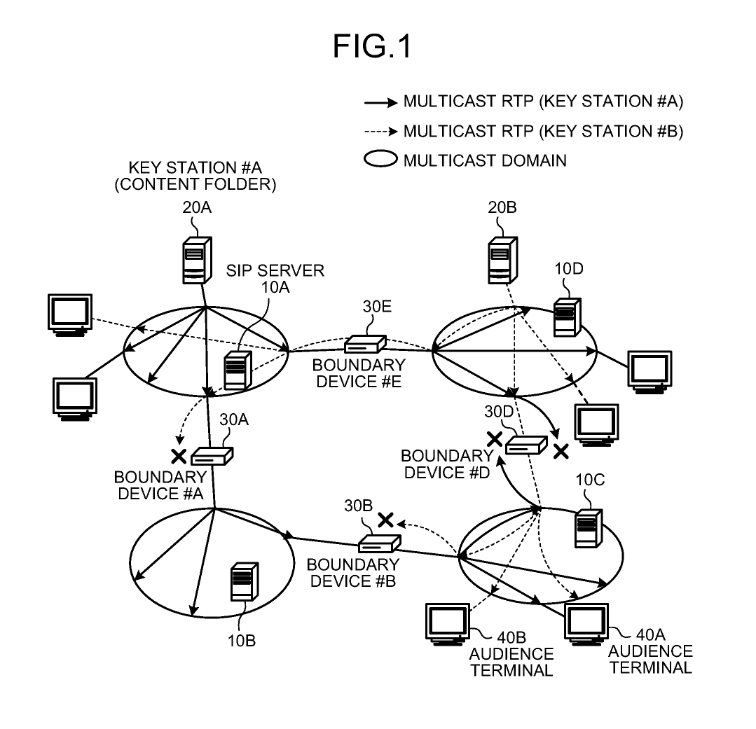

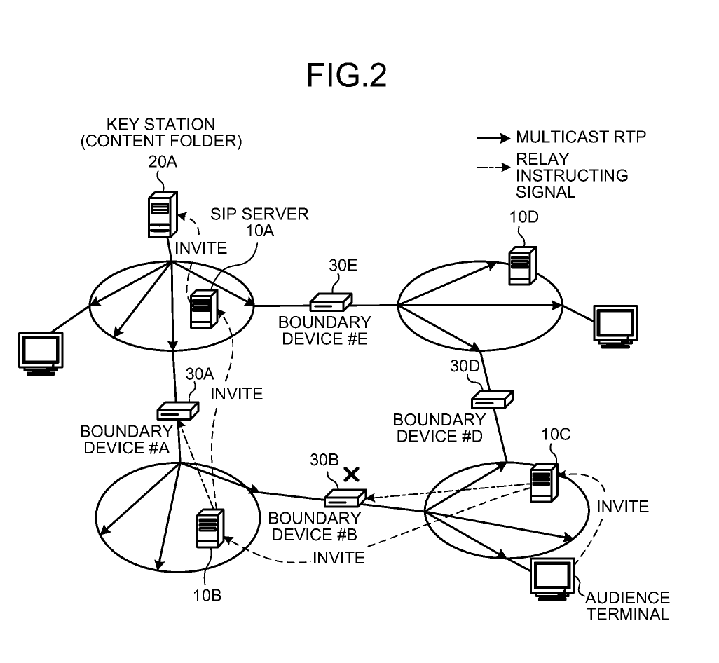

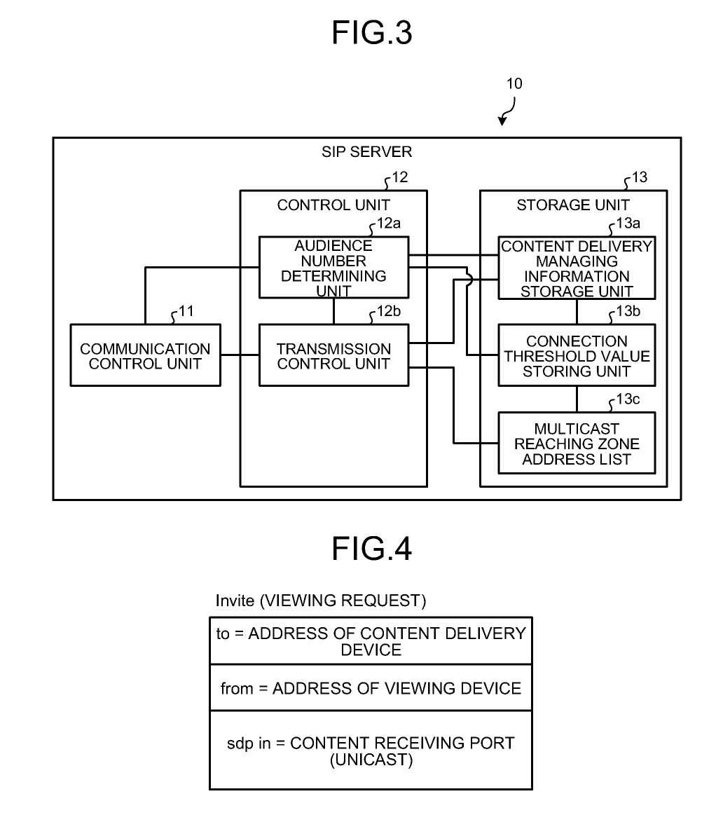

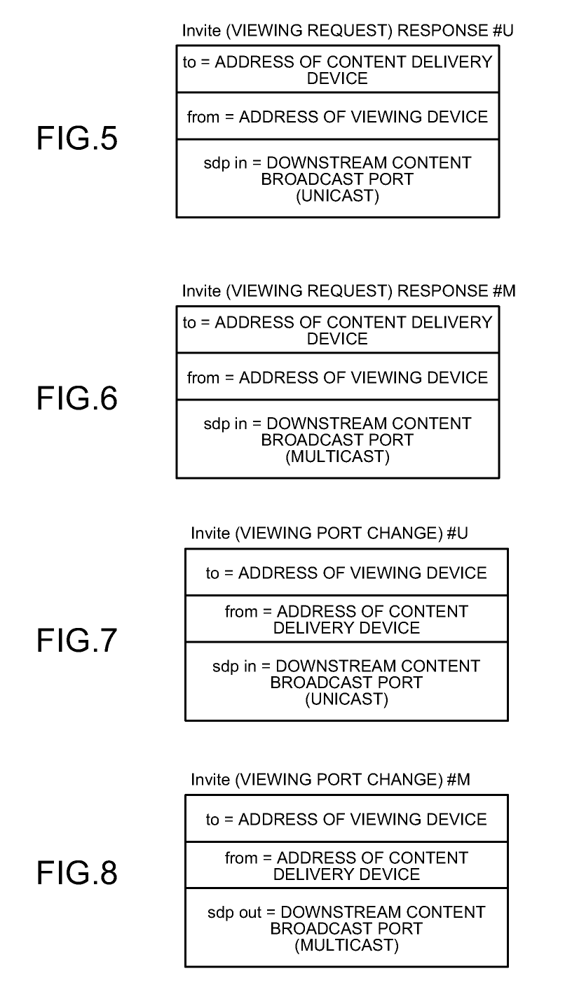

First, the configurations of the content delivery system and an SIP server 10 will be described with reference to FIG. 1. FIG. 1 is an example of the configuration of a network that relays an IPTV broadcast. FIG. 2 is an example of formation of a multicast delivery path. FIG. 3 is a block diagram illustrating the configuration of an SIP server according to the first embodiment. FIG. 4 is an example of the data configuration of a viewing request. FIG. 5 is an example of the data configuration of a response #U to a viewing request. FIG. 6 is an example of the data configuration of a response #M to a viewing request.

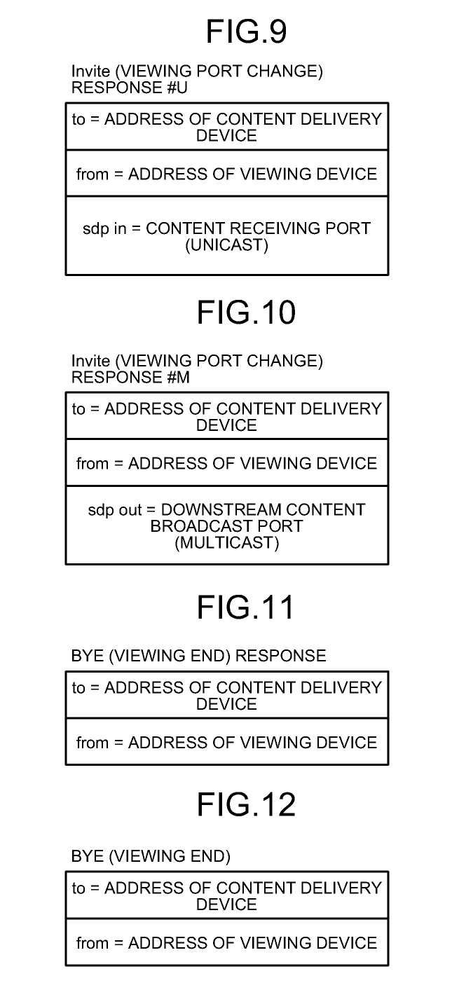

FIG. 7 is an example of the data configuration of a viewing port change #U. FIG. 8 is an example of the data configuration of a viewing port change #M. FIG. 9 is an example of the data configuration of a response to a viewing port change #U. FIG. 10 is an example of the data configuration of a response to a viewing port change #M. FIG. 11 is an example of the data configuration of viewing end. FIG. 12 is an example of the data configuration of viewing end.

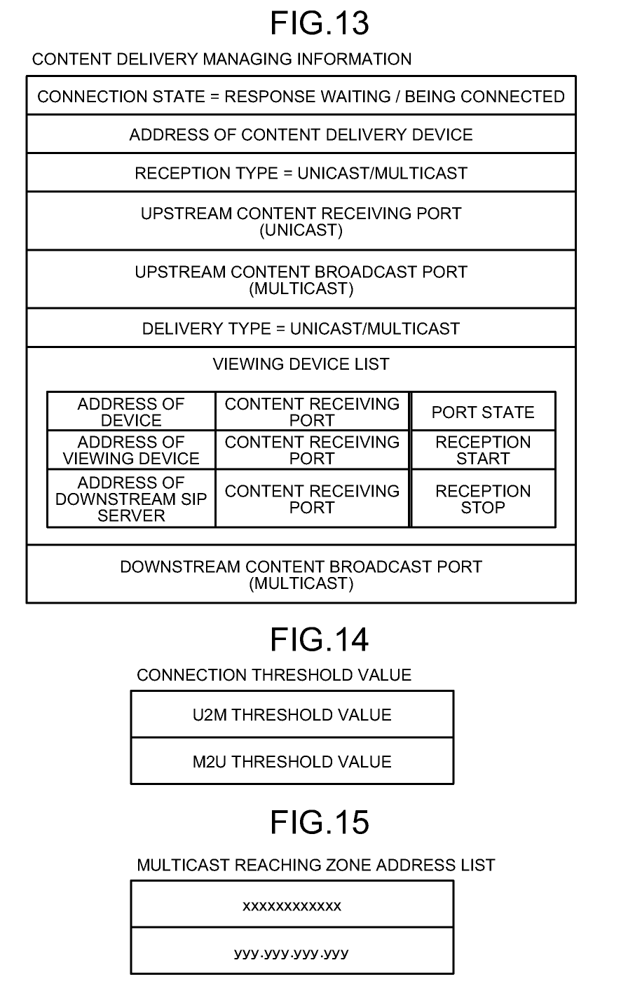

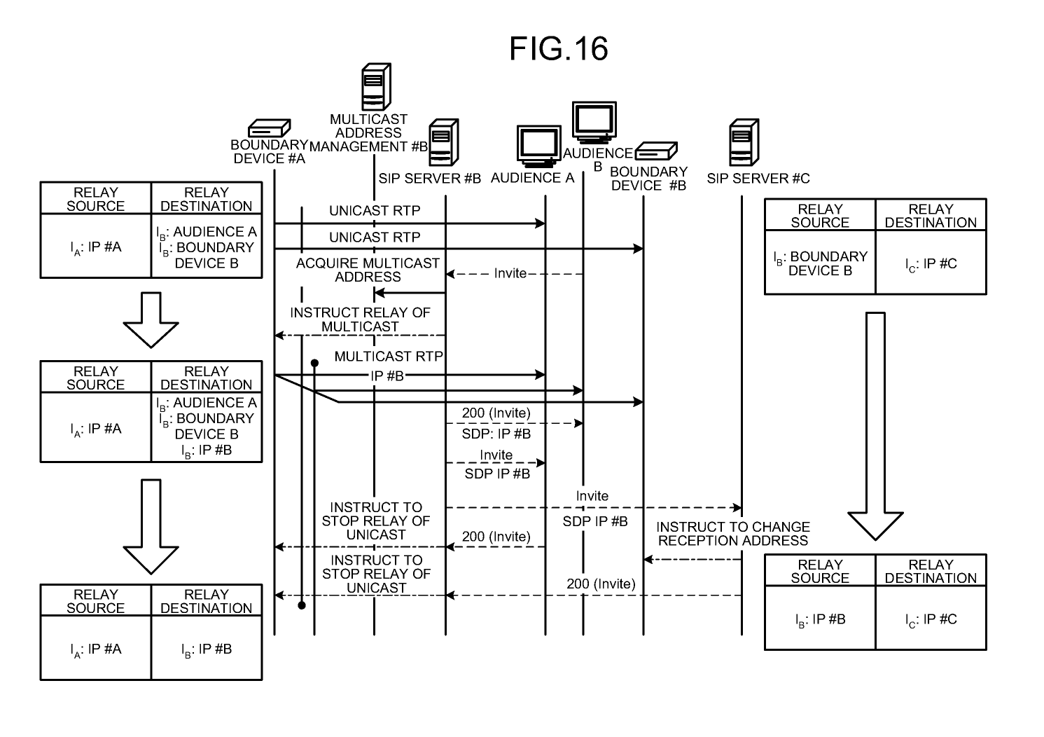

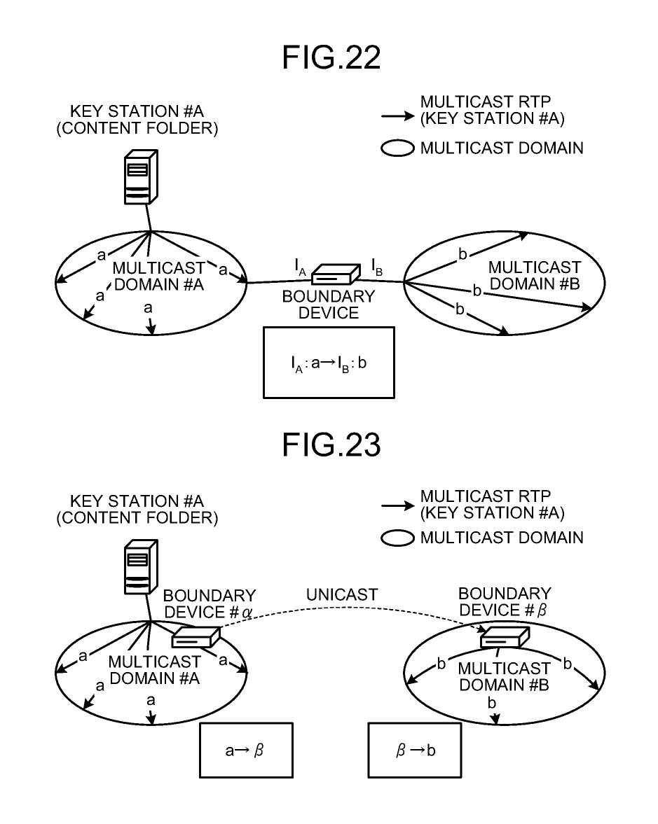

FIG. 13 is a diagram illustrating an example of the data configuration of content delivery managing information. FIG. 14 is a diagram illustrating an example of a connection threshold value. FIG. 15 is a diagram illustrating an example of a multicast-reaching-zone address list. FIGS. 16 to 21 are diagrams illustrating transitions of a transmission destination address converting table. FIGS. 22 to 24 are diagrams illustrating examples of a connection between multicast domains through a boundary device.

First, the content delivery system including the SIP server 10 according to the first embodiment will be described with reference to FIG. 1. As illustrated in the figure as an example, the content delivery system includes: a plurality of SIP servers 10A to 10D; a plurality of key stations (content folders) 20A and 20B; a plurality of boundary devices 30A to 30E; and a plurality of audience terminals 40A and 40B, which are interconnected through a network.

In the content delivery system, RTP packets of an IPTV broadcast are delivered in a multicast mode from the plurality of key stations 20A and 20B to the viewing devices 40A and 40B connected to the network through the boundary devices 30A to 30E.

In the content delivery system, as illustrated in FIG. 2, a multicast delivery path is formed between a key station 20 and the audience terminal 40. In other words, in the content delivery system, the SIP server 10 receives a viewing request (denoted by “INVITE” in FIG. 2) issued by the audience terminal 40, and a path is formed among multicast domains to be passed through in accordance with the viewing request.

Subsequently, the configuration of the SIP server 10 illustrated in FIG. 1 will be described with reference to FIG. 3. As illustrated in the figure, this SIP server 10 includes a communication control unit 11, a control unit 12, and a storage unit 13. The SIP server 10 is connected to the key station (content folder) 20, a boundary device 30, and the audience terminal 40 through the network. The process of each of the units will be described below.

The communication control unit 11 controls communication of various types of information that are exchanged between the key station 20, the boundary device 30, and the audience terminal 40 that are connected thereto. In more detail, the communication control unit 11 receives a viewing request (see FIG. 4) that is a request, which is transmitted from the audience terminal 20, for starting viewing and transmits a response (FIGS. 5 and 6) to a viewing request, which is a response to the viewing request, to the audience terminal.

The viewing request, as illustrated in FIG. 4, contains, as information, “sdp in=content receiving port” that represents a port to receive contents through unicast delivery, “to=address of content delivery device” as the address of the key station 20 serving as the viewing request destination and “from=address of viewing device” as the address of the viewing device 20 serving as a request source.

In addition, the communication control unit 11 transmits a response #U to a viewing request or a response #M to a viewing request as a response to the viewing request. The response #U to a viewing request, as illustrated in FIG. 5, contains, as information, “sdp in=content receiving port” that represents a port to receive contents through unicast delivery, “to=address of content delivery device” as the address of the key station 20, and “from=address of viewing device” as the address of the viewing device 20.

The response #M to a viewing request, as illustrated in FIG. 6, contains, as information, “sdp out=downstream content broadcast port” that represents a port to receive contents through a multicast delivery, “to=address of content delivery device”, and “from=address of viewing device”.

In addition, the communication control unit 11 receives a viewing exchange port #U and another viewing exchange port #U, and transmits a response to the viewing exchange port #U and a response to the viewing exchange port #U. The viewing exchange port #U, as illustrated in FIG. 7, includes “sdp in=content receiving port” that instructs to change the content receiving port of a viewing device 40 together with “to=address of viewing device” and “from=address of content delivery device”, as information.

The viewing exchange port #M, as illustrated in FIG. 8, includes “sdp out=downstream content broadcast port” that instructs to change the content receiving port of the viewing device 40 together with “to=address of viewing device” and “from=address of content delivery device”, as information.

The viewing exchange port #U, as illustrated in FIG. 9, includes “sdp in=content receiving port” that instructs to change the content receiving port of the viewing device 40 together with “to=address of content delivery device” and “from=address of viewing device”, as information.

The viewing exchange port #M, as illustrated in FIG. 10, includes “sdp out=downstream content broadcast port” that instructs to change the content receiving port of the viewing device 40 together with “to=address of content delivery device” and “from=address of viewing device”, as information.

In addition, the communication control unit 11 receives a viewing end and transmits a response to the viewing end. The viewing end and the response to the viewing end, as illustrated in FIGS. 11 and 12, represent the end of viewing of “to=address of content delivery device” and “from=address of viewing device”.

The storage unit 13 stores data and program to be used in various processes performed by the control unit 12 therein, and particularly includes a content delivery managing information storing unit 13a, a connection threshold value storing unit 13b, and a multicast reaching zone address list 13c.

The content delivery managing information storing unit 13a stores information for use in managing the delivery of contents. In more detail, the content delivery managing information storing unit 13a, as illustrated in FIG. 13, stores a “connection state” that represents whether the connection state is “response waiting” or “being connected” as content delivery managing information and the “address of the content delivery device” as the address of the key station 20.

In addition, the content delivery managing information storing unit 13a, as the content delivery managing information, stores a “reception type” that represents the unicast or a reception type of the unicast, an “upstream content receiving port” that represents a port used for unicast communication, an “upstream content receiving port” that represents an upstream port used for multicast communication, a “delivery type” that represents unicast or a delivery type of the unicast, a “viewing device list” that represents information on a viewing device that is currently used in viewing a content, and a “downstream content broadcast port” that represents a downstream port for multicast communication.

The connection threshold value storing unit 13b stores threshold values for use in determining whether to switch between multicast and unicast. In more detail, the connection threshold value storing unit 13b, as illustrated in FIG. 14, stores a “U2M threshold value” that is a threshold value used to determine whether switching from unicast to multicast is made and an “M2U threshold value” that is a threshold value used to determine whether switching from multicast to unicast is made.

The multicast reaching zone address list 13c is a list used to determine whether a multicast packet can reach. In more detail, the multicast reaching zone address list 13c, as illustrated in FIG. 15, stores a list of addresses within a multicast reaching zone. In other words, when there is a viewing request from a content receiving port that is not stored in the multicast reaching zone address list 13c, a viewing from the outside of the multicast reaching zone is determined, and transmission is performed in a unicast mode.

The control unit 12 includes an internal memory that is used to store programs that define various process sequences and the like and data that are required, and performs various processes according to the programs. Particularly, the control unit 12 includes an audience number determining unit 12a and a transmission control unit 12b.

The audience number determining unit 12a determines whether the number of delivery requests of requesting for delivery from audience terminals 40 within the multicast domain is a predetermined threshold value or more. In more detail, the audience number determining unit 12a determines whether the number of increasing audiences is the “U2M threshold value” stored in the connection threshold value storing unit 13b, or more when it receives viewing requests from viewing devices.

In addition, the audience number determining unit 12a determines whether the number of decreasing audiences is less than the “M2U threshold value” stored in the connection threshold value storing unit 13b when it receives viewing ends from viewing devices. Then, the audience number determining unit 12a notifies the transmission control unit 12b of the result of the determination.

The transmission control unit 12b controls to perform multicast transmission in a case where the number of delivery requests is a predetermined threshold value or more and controls to perform unicast transmission in a case where the number of the delivery requests is less than the predetermined threshold value.

In more detail, when the determination result from the audience number determining unit 12a indicates that the number of the audiences is the “U2M threshold value” or more, the transmission control unit 12b controls to switch from unicast transmission to multicast transmission. On the other hand, when the determination result from the audience number determining unit 12a indicates that the number of the audiences is less than the “M2U threshold value”, the transmission control unit 12b controls to switch from multicast transmission to unicast transmission.

In addition, the transmission control unit 12b performs unicast transmission for delivery to an address, which is not stored in the multicast reaching zone address list 13c, outside the multicast reaching zone.

Here, as a transmission control process, a process of changing the transmission destination address converting table of the boundary device 30 will be described with reference to examples illustrated in FIGS. 16 to 21. FIG. 16 illustrates an example in which an SIP server has received viewing requests and the number of audiences located within a multicast domain, in which connections are controlled by the SIP server, is more than the “U2M threshold value”.

As illustrated in the figure, when viewing requests are received, and the number of audiences located within the multicast domain, in which connections are controlled by the SIP server #B, is determined to be more than the threshold value; the SIP server #B notifies a boundary device #A of a multicast relay instruction and adds “I_{B}: IP#B” to a relay destination of the transmission destination address converting table as a multicast address.

Then, when responses to the viewing port change are received from a viewing terminal #A and an SIP server #C, the SIP server #B sequentially instructs the boundary device #A to stop transmission to unicast addresses (“I_{B}: audience A” and “I_{B}: boundary device B”) of the devices.

In addition, when a viewing port change is received from the SIP server #B, an SIP server #C instructs a boundary device 30B to start receiving a content at a multicast address designated by the viewing port change and changes the “I_{B}: boundary device B” of the relay source of the transmission destination address converting table to “I_{B}: IP#B”.

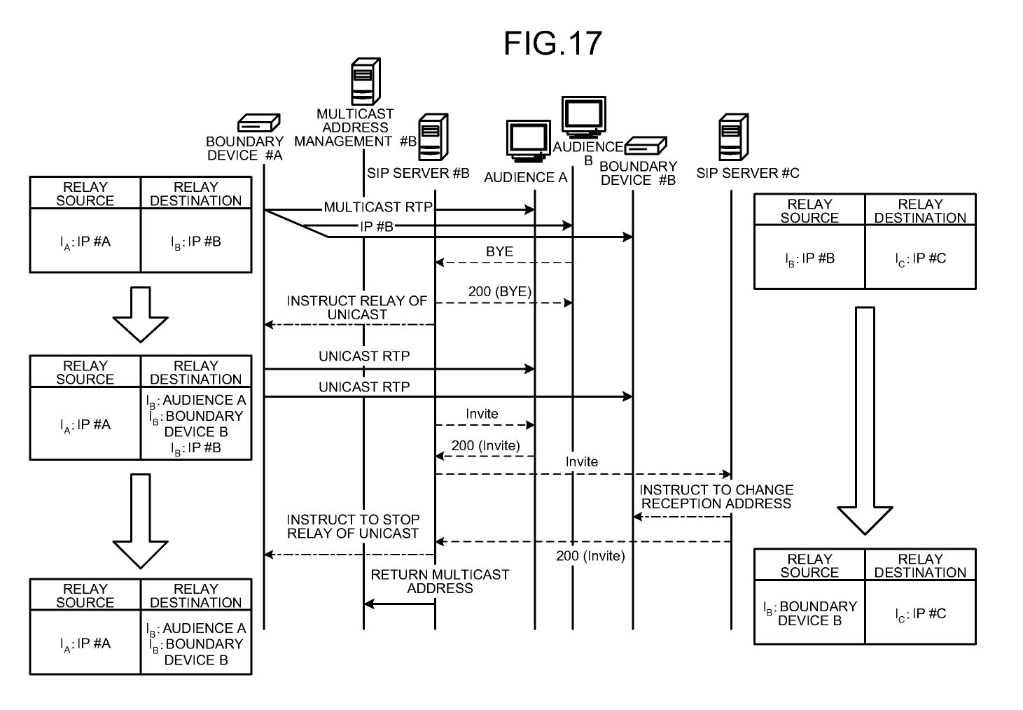

The example illustrated in FIG. 17 is an example in which viewing ends are received by an SIP server, and the number of audiences located within a multicast domain, in which connections are controlled by the SIP server, is less than the “M2U threshold value”. As illustrated in the figure, when viewing ends are received by the SIP server #B, and the number of audiences located within the multicast domain, in which connections are controlled by the SIP server #B, is determined to be less than the threshold value, the SIP server #B notifies the boundary device #A of a multicast relay instruction and adds unicast addresses (“I_{B}: audience A” and “I_{B}: boundary device B”) to relay destinations of the transmission destination address converting table.

Then, when responses to the viewing port change are received from the viewing terminal #A and the SIP server #C, the SIP server #B instructs the boundary device #A to stop transmission to the devices from the multicast address (“I_{B}: IP#B).

In addition, at the arrival of a viewing port change from the SIP server #B, the SIP server #C instructs the boundary device 30B to start receiving a content from a multicast address designated by the viewing port change and changes the “I_{B}: IP#B” of the relay source of the transmission destination address converting table to “I_{B}: boundary device B”.

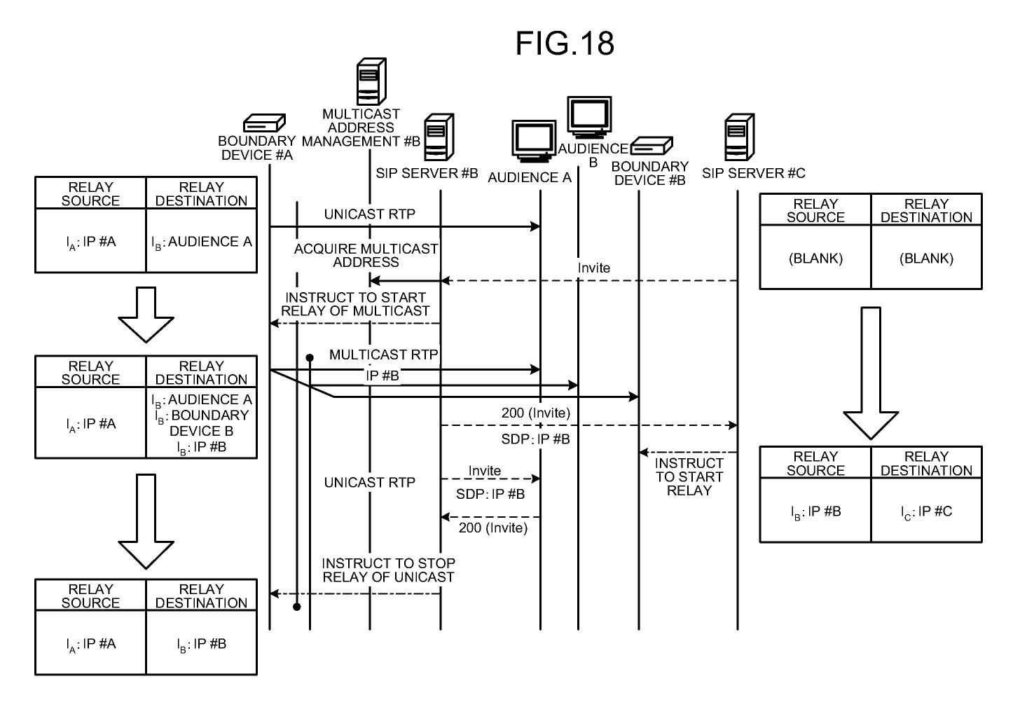

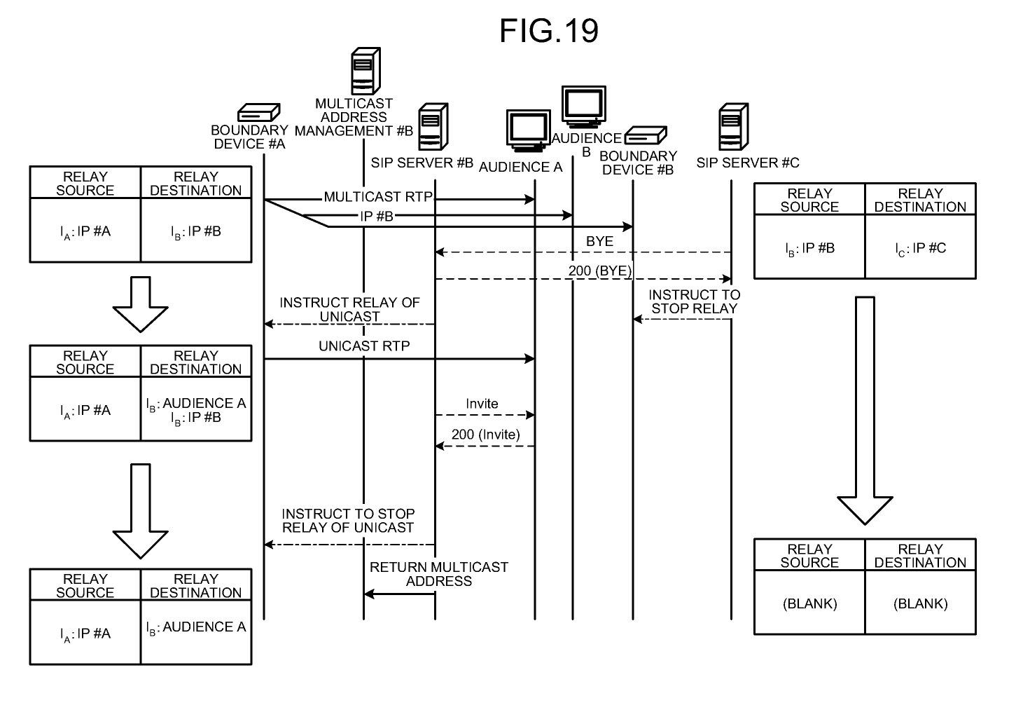

The example illustrated in FIG. 18 represents the appearance of the transition of the transmission destination address changing table when viewing requests are received, and the number of audiences located outside the multicast domain is increased to be more than the “U2M threshold value”. The example illustrated in FIG. 19 represents the appearance of the transition of the transmission destination address changing table in a case where a viewing end is received, and the number of audiences located outside the multicast domain is decreased to be less than the “M2U threshold value”.

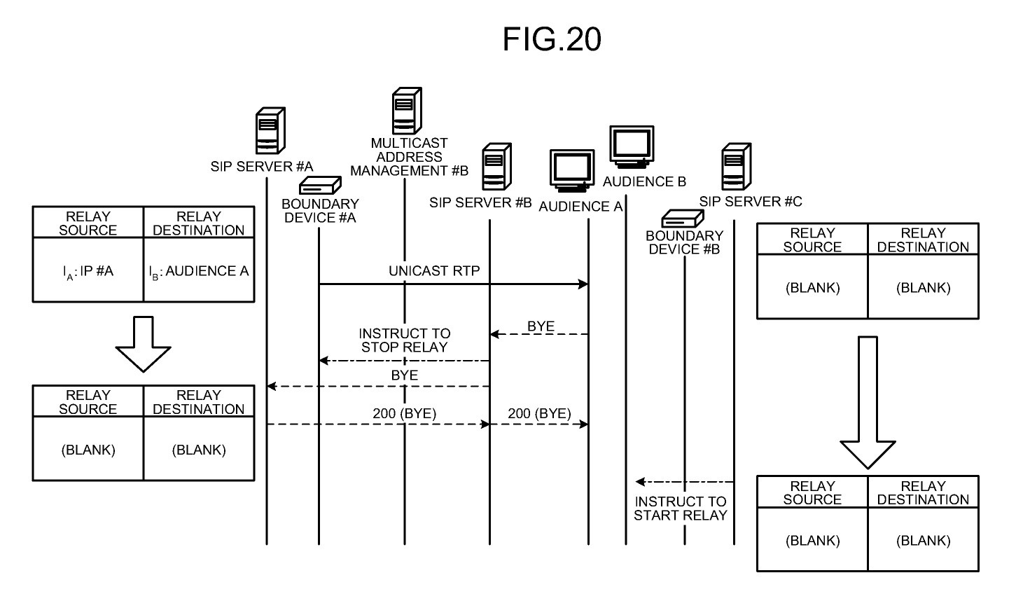

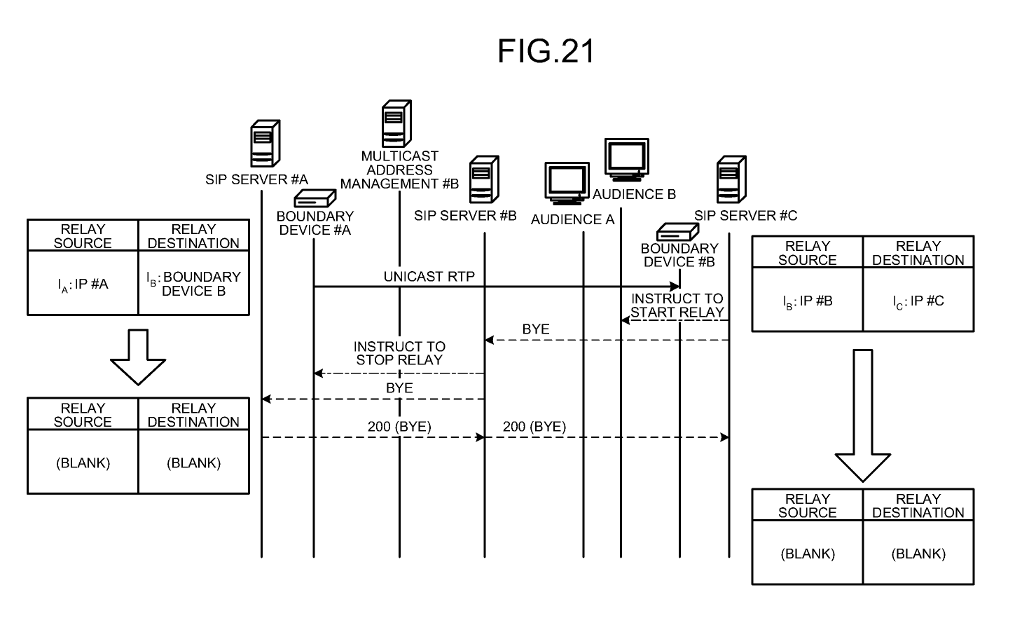

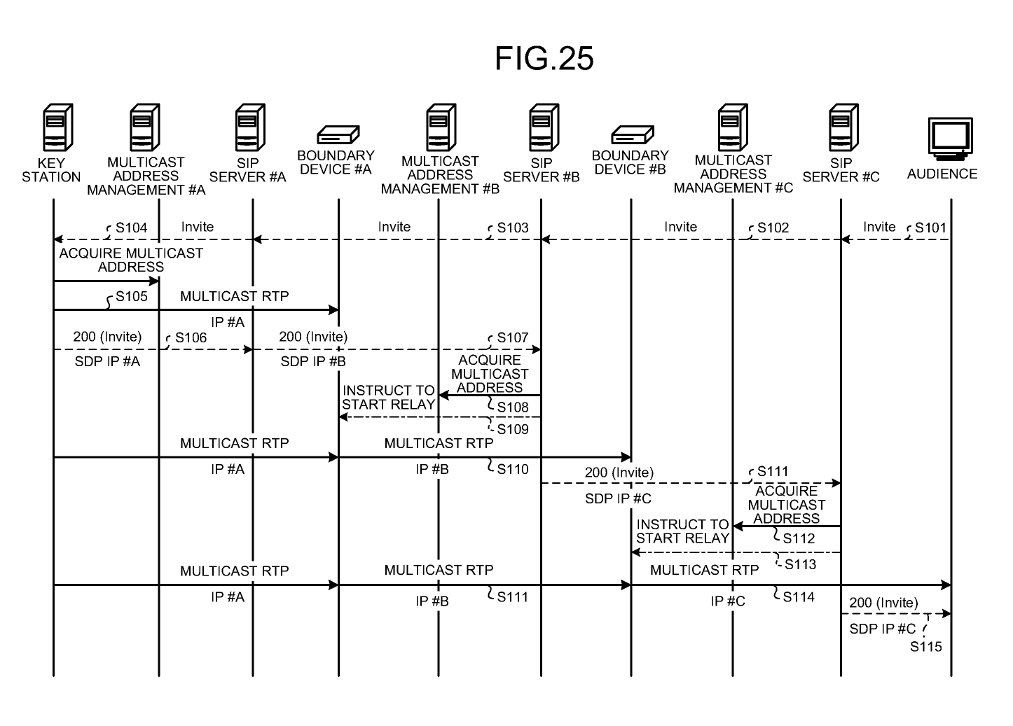

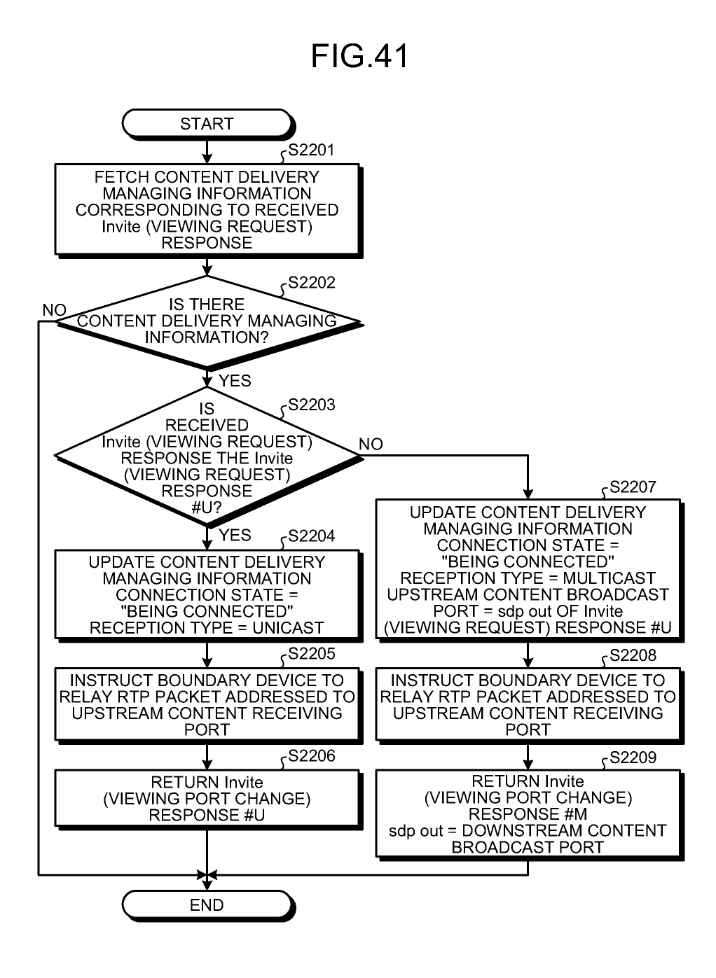

In addition, FIG. 20 represents the appearance of the transition of the transmission destination address changing table in a case where the last audience located within the multicast domain ends viewing. The example illustrated in FIG. 21 represents the appearance of the transition of the transmission destination address changing table in a case where an audience located outside the multicast domain ends viewing. The flow of the process will be further detailed in the description below in relation with FIGS. 25 to 45.

Here, examples of a connection between multicast domains through a boundary device 20 are illustrated in FIGS. 22 to 24. The example illustrated in FIG. 22 is applied to an environment in which a multicast packet from an upstream multicast domain reaches the boundary device, and the boundary device 20 transmits a packet, which is addressed to a multicast address #a, from a multicast domain #A, as a packet addressed to a multicast address #b within a multicast domain #B in accordance with an instruction from an SIP server.

Then, the boundary device 20 changes only the destination address without changing the transmission source address. In addition, the boundary device 20 discards a packet addressed to a multicast address for which a relay is not designated.

The example illustrated in FIG. 23 is an example that is applied to an environment in which a multicast packet cannot reach a boundary device from an upstream multicast domain. A packet addressed to a multicast address #a from a multicast domain #A is transmitted by a boundary device α in the unicast mode toward a boundary device β in accordance with an instruction transmitted from an SIP server, and the packet transmitted in the unicast mode is transmitted by the boundary device β as a packet addressed to a multicast address #b within a multicast domain #B.

Then, both the boundary devices change only the destination address without changing the transmission source address. In addition, a packet addressed to a multicast address for which a relay is not designated is discarded.

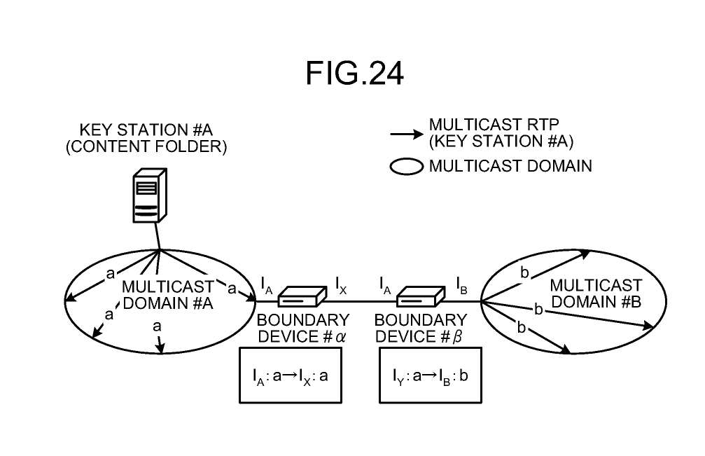

The example illustrated in FIG. 24 is an example that is applied to an environment in which a multicast packet reaches a boundary device from an upstream multicast domain. In a configuration in which a boundary device α and a boundary device β are directly connected to each other (physically or logically), a packet addressed to a multicast address #a from a multicast domain #A is directly relayed and transmitted by the boundary device α toward the boundary device β in accordance with an instruction transmitted from an SIP server, and the transmitted packet is transmitted by the boundary device β as a packet addressed to a multicast address #b within a multicast domain #B.

At this time, the transmission source address is the address of a key station (a generation source of the multicast packet). Then, both the boundary devices do not change the transmission source address. In addition, a packet addressed to a multicast address for which a relay is not designated is discarded.

Process of Multicast Delivery System

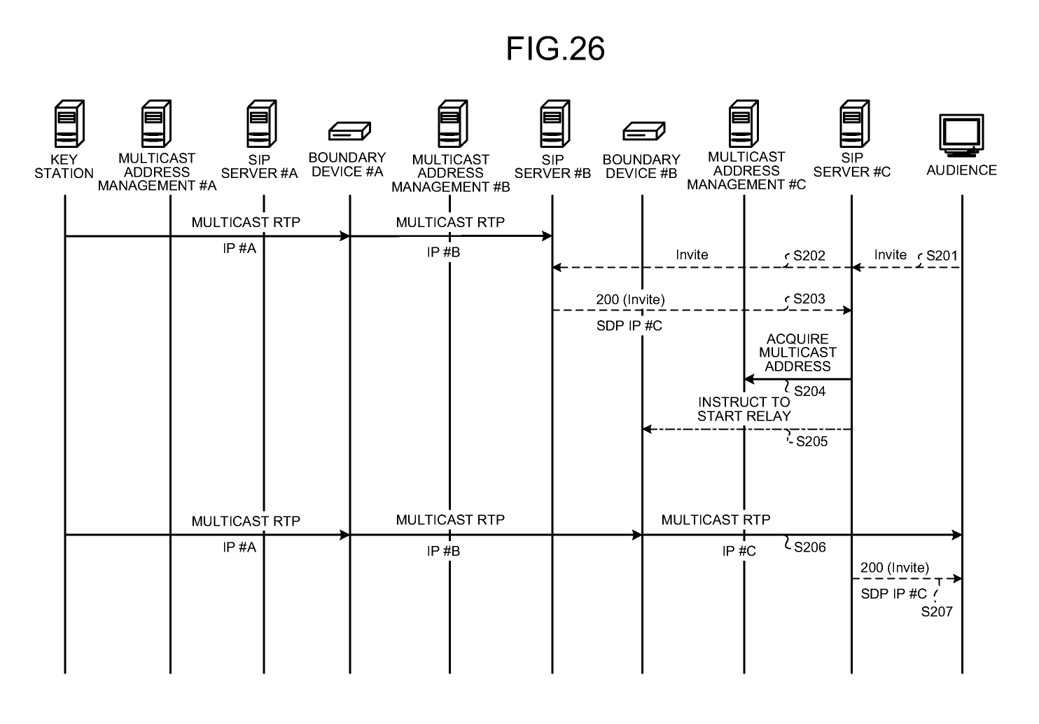

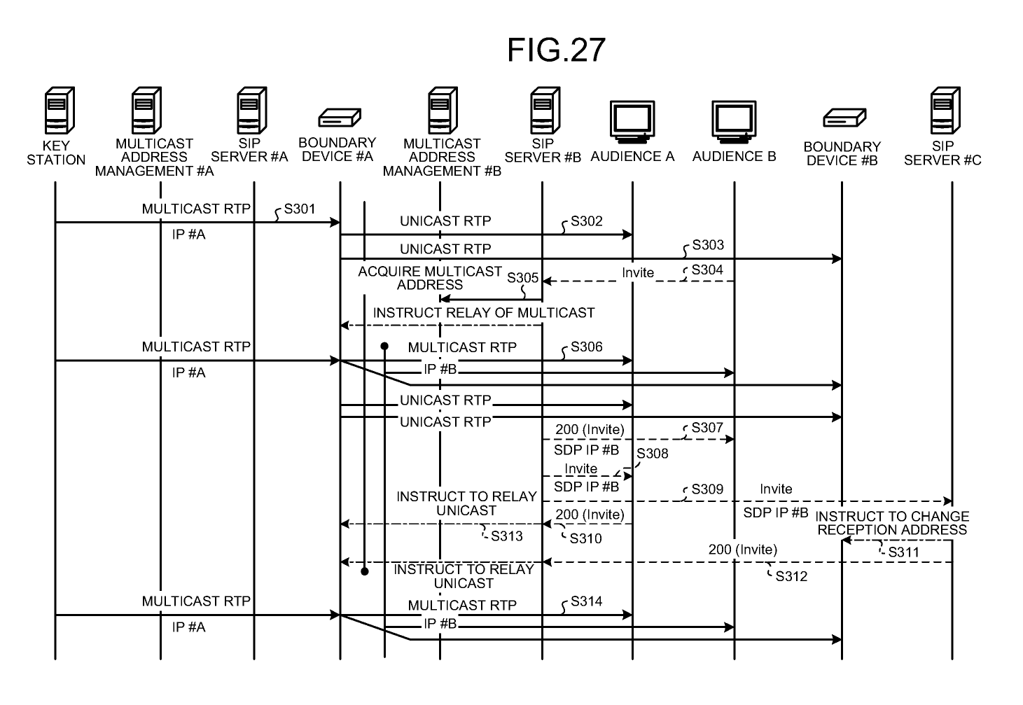

Next, the entire process of a multicast delivery system according to the first embodiment will be described with reference to FIGS. 25 to 32. FIG. 25 is a diagram of a sequence of forming a multicast path between an audience and a content folder when the first audience issues a viewing request. FIG. 26 is a diagram of a sequence of forming a multicast path between an audience and a content folder when the audience issues a viewing request in a state in which another audience is already receiving a broadcast from the desired content folder. FIG. 27 is a diagram of a sequence of change from unicast to multicast in a case where it is determined that multicast delivery reduces the network traffic more than unicast delivery due to an increase in the number of audiences within a multicast domain.

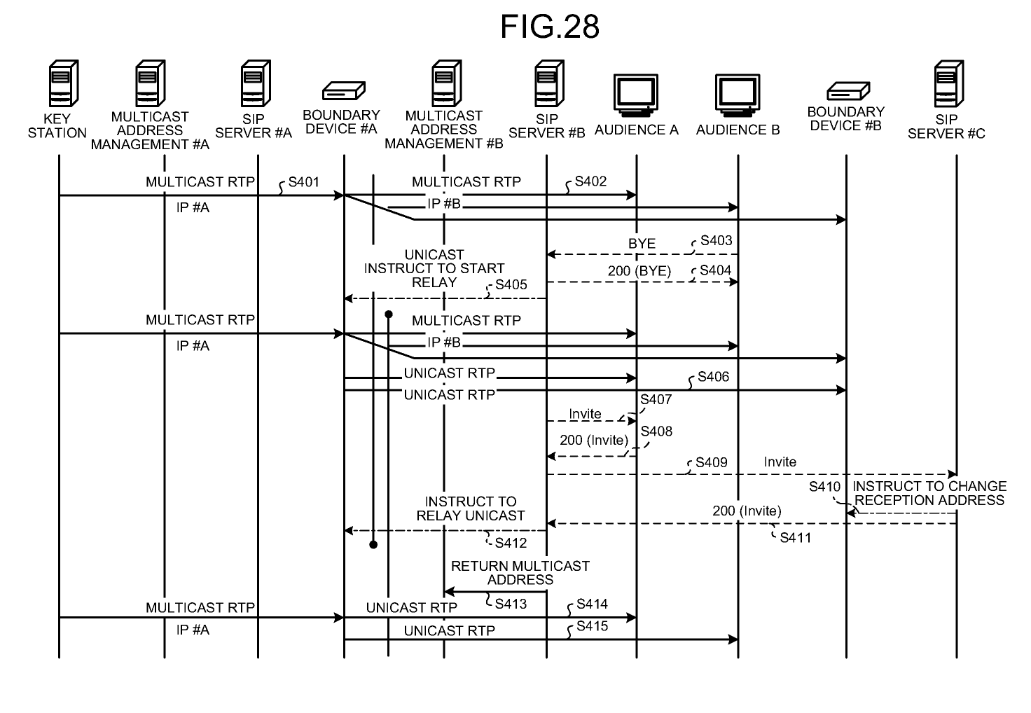

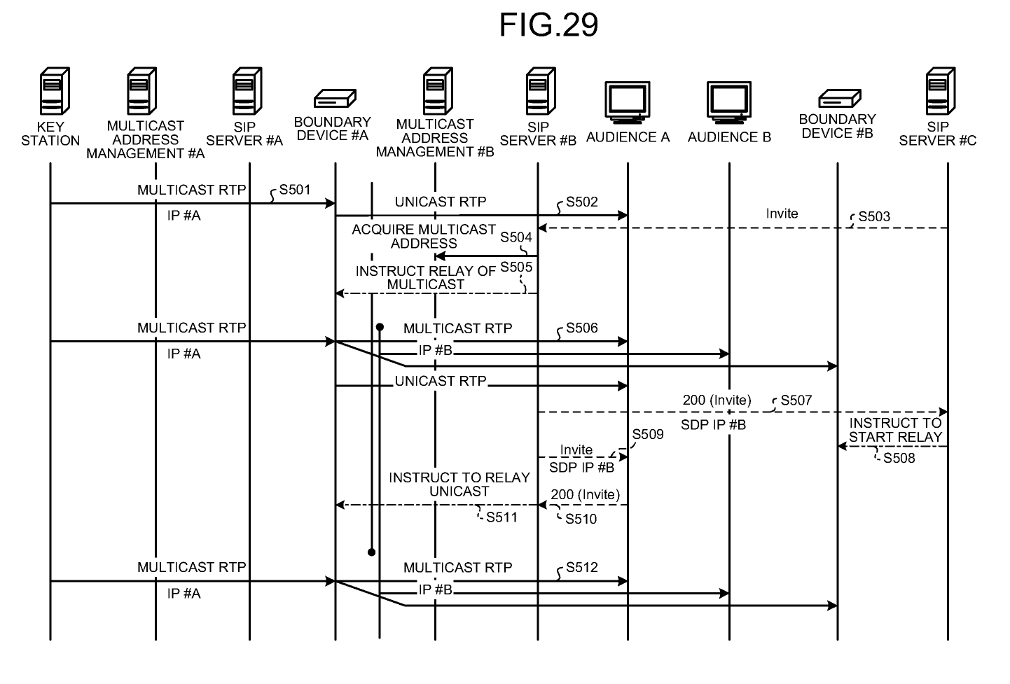

FIG. 28 is a diagram of a sequence of a change from multicast to unicast in a case where it is determined that unicast delivery reduces the network traffic more than multicast delivery due to a decrease in the number of audiences within a multicast domain. FIG. 29 is a diagram of a sequence of a change from unicast to multicast in a case where it is determined that multicast delivery reduces the network traffic more than unicast delivery due to an increase in the number of audiences present out of the multicast domain.

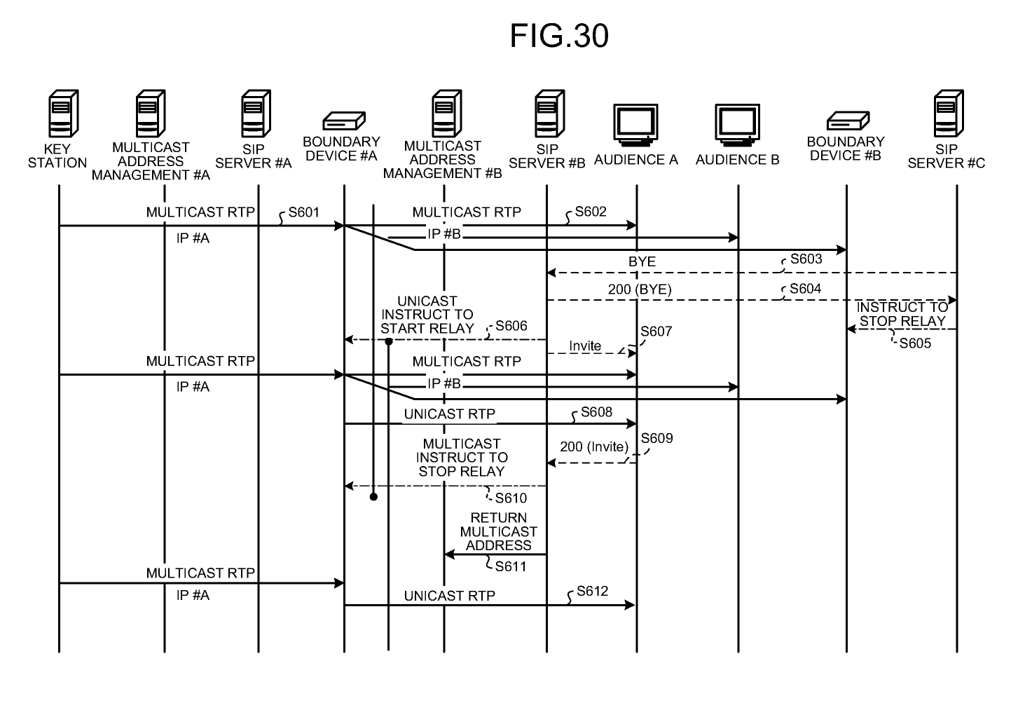

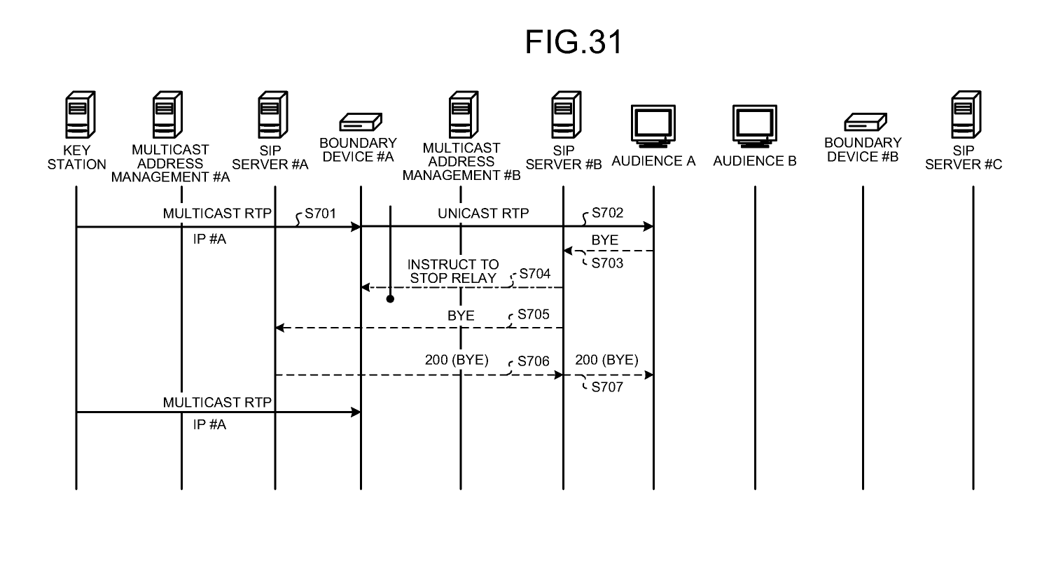

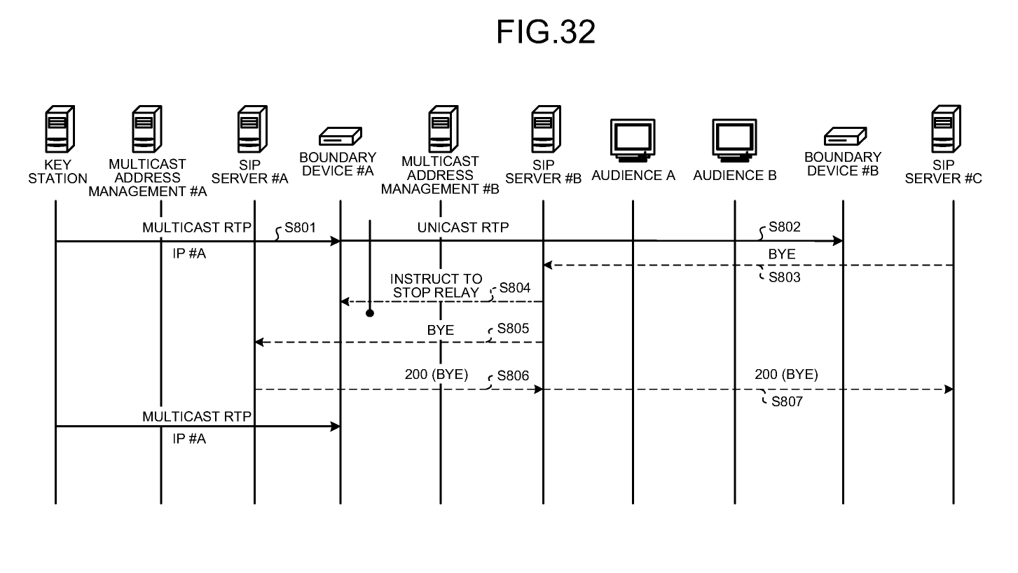

FIG. 30 is a diagram of a sequence of a change from multicast to unicast in a case where it is determined that unicast delivery reduces the network traffic more than multicast delivery due to a decrease in the number of audiences present out of the multicast domain. FIG. 31 is a sequence diagram in a case where a content folder is notified of a viewing end in a case in which the last audience is an audience present within the multicast domain. FIG. 32 is a sequence diagram in a case where a content folder is notified of a viewing end in a case in which the last audience is an audience present within the multicast domain.

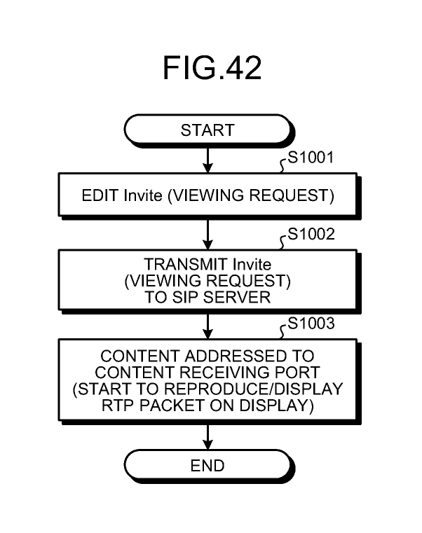

First, a case where the first audience issues a viewing request will be described. When the audience selects a program of a key station 20 and performs an operation for starting viewing, a viewing terminal 40 transmits a viewing request addressed to the key station 20 (see FIG. 42).

In other words, as illustrated in FIG. 25, the audience terminal 40 transmits a viewing request to an SIP server 10C that manages connection control within a multicast domain to which the audience terminal 40 belongs in step S101. Then, the SIP server 10C transmits the viewing request to an SIP server 10B that manages connection control of an adjacent multicast domain in step S102.

Then, the SIP server 10B transmits the viewing request to the key station 20 in step S104 through an SIP server 10A that manages connection control of an adjacent multicast domain in step S103. The key station 20 that has received the viewing request starts broadcasting contents in step S105. In addition, the key station 20 loads address information of an IPTV broadcast on a response to a viewing request, and sends the response back to in step S106.

Subsequently, when the response to the viewing request is received from the key station 20, the SIP server 10A transmits the response to the viewing request to the SIP server 10B in step S107. Then, the SIP server 10B acquires the multicast address in step S108 and instructs the boundary device 30A to start a relay in step S109. The boundary device 30A starts the relay of the content within the multicast domain in step S110.

In addition, the SIP server 10B relays the response to the viewing request that has been received from the SIP server 10A to the SIP server 10C in step S111. The SIP server C, similarly, acquires the multicast address in step S112 and instructs the boundary device 30B to start a relay in step S113.

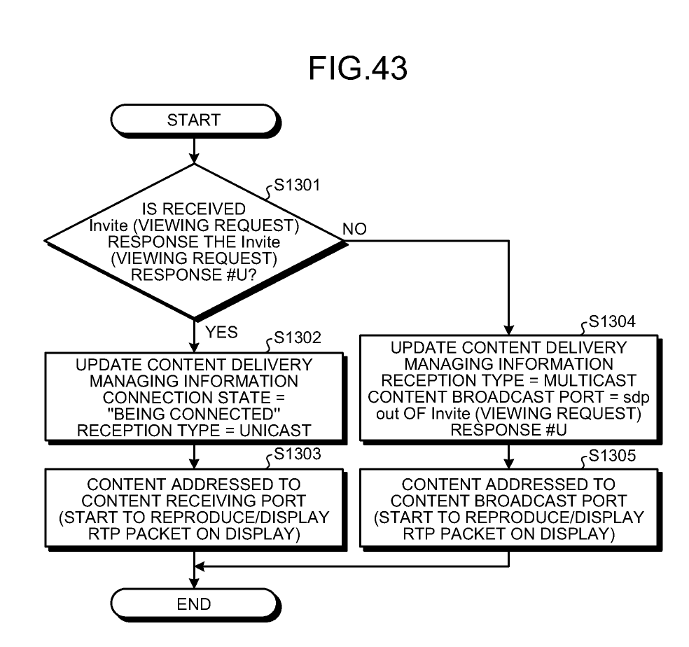

The boundary device 30B starts the relay of contents within the multicast domain in step S114. In addition, the SIP server 10C relays the response to the viewing request that has been received from the SIP server 10B to the viewing device 40 in step S115. Thereafter, the viewing device 40 completes to set up a broadcast path for the key station 20 (see FIG. 43).

Subsequently, in a case where another audience located within the multicast domain views a content, the viewing request made from the viewing terminal 40 will be described with reference to FIG. 26. When the audience selects a program of the key station 20 and performs an operation of starting the viewing of the content, the viewing terminal 40 transmits a viewing request addressed to the key station 20 (see FIG. 42).

Thereafter, as illustrated in FIG. 26, an SIP server 10C that manages connection control within a multicast domain to which the viewing terminal 40 belongs receives a viewing request from the viewing terminal 40 in step S201. Then, the SIP server 10C relays the viewing request addressed to the key station 20 to an SIP server 10B in step S202.

Then, the SIP server 10B that has received the viewing request transmits a response to the viewing request, which is addressed to the viewing terminal 40, to the SIP sever C in step S203. In addition, the SIP server 10C acquires a multicast address in step S204 and instructs a boundary device 30B to start a relay in step S205.

Then, the boundary device 30B starts the relay of contents within the multicast domain in step S206. In addition, the SIP server 10C that has received the response to the viewing request from the SIP server 10B transmits the response to the viewing request to the audience terminal 40 in step S207. Thereafter, the viewing device 40 completes to set up a broadcast path for the key station 20.

Next, an operation performed in a case where the number of audiences within the multicast domain is increased, and switching from unicast delivery to multicast delivery is performed will be described with reference to FIG. 27.

As illustrated in the figure, in a case where an SIP server 10A performs multicast delivery in step S301, and an SIP server B controls viewing terminals 40A and 40B so as to perform unicast delivery in steps S302 and S303, when the viewing terminal 40B transmits a viewing request addressed to a content filter in accordance with the operation of an audience, the viewing request arrives at the SIP server 10B in step S304.

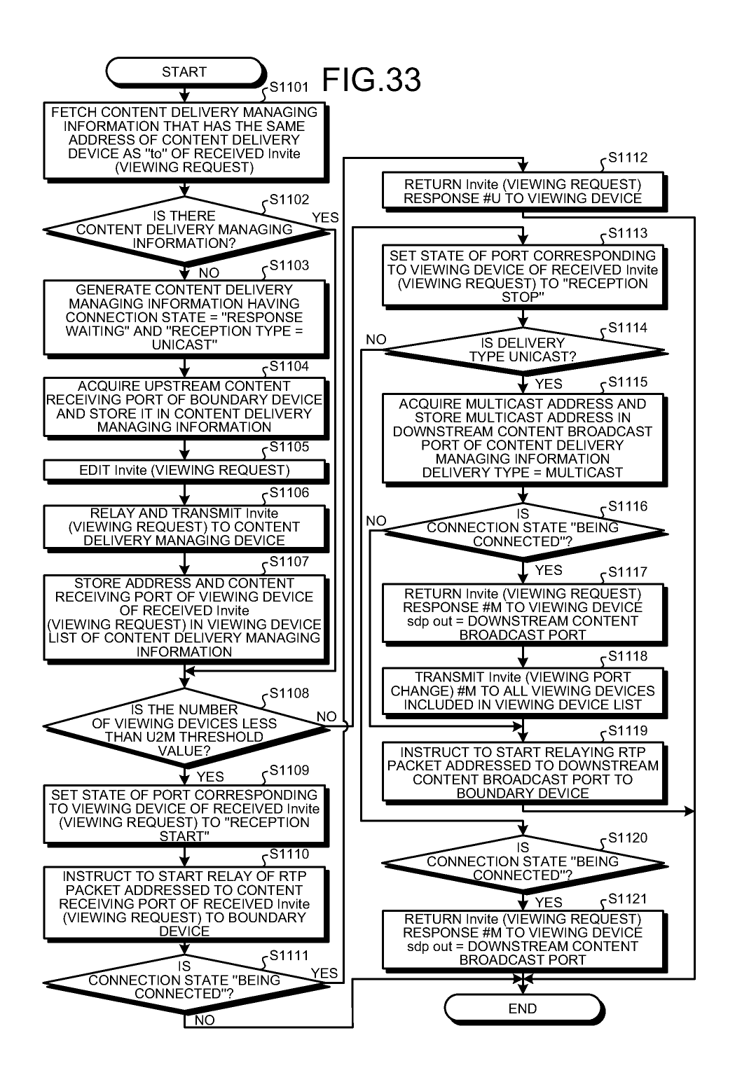

Then, the SIP server 10B receives the viewing request. When it is determined that the number of audiences within a multicast domain, in which connections are controlled by the SIP server 10B, is more than a threshold value, the SIP server 10B transmits a viewing port change toward all the viewing terminals that are currently in the process of viewing a content (see FIG. 33).

In addition, the SIP server 10B instructs a boundary terminal 30A to start multicast delivery in step S305 and controls the boundary terminal 30A to perform multicast delivery in step S306. Furthermore, the SIP server 10B returns a response to the viewing request to the viewing terminal 40B in step S307.

Subsequently, when the response to the viewing request is received from the SIP server 10B in step S307, the viewing terminal 40B starts to receive a content at a multicast address designated by the response to the viewing request in step S314.

In addition, when a viewing port change is received from the SIP server 10B in step S308, the viewing terminal 40A starts to receive a content at a multicast address designated by the response to the viewing request and returns a response to the viewing port change to the SIP server 10B in step S310.

When the viewing port change is received from the SIP server 10B in step S309, the SIP server 10C instructs the boundary device 30B to start to receive a content at a multicast address designated by the viewing port change in step S311 and returns a response to the viewing port change to the SIP server 10B in step S312.

Then, when the response to the viewing port change is received from the viewing terminal 40A and the SIP server 10C, the SIP server 10B sequentially instructs the boundary device to stop transmission at the unicast address toward the devices in step S313. Thereafter, the SIP server 10B controls the viewing terminals 40A and 40B to perform multicast delivery in step S314.

Next, an operation performed in a case where the number of audiences within a multicast domain is decreased, and switching from the multicast delivery to the unicast delivery is made will be described with reference to FIG. 28.

As illustrated in the figure, an SIP server 10A performs multicast delivery in step S401, and an SIP server 10B controls viewing terminals 40A and 40B and a boundary device 20B so as to perform multicast delivery in step S402. Then, when a viewing end is transmitted to a content folder by the viewing terminal 40B in accordance with the operation of an audience, the SIP server 10B receives the viewing end in step S403 and replies a response to the viewing end in step S404.

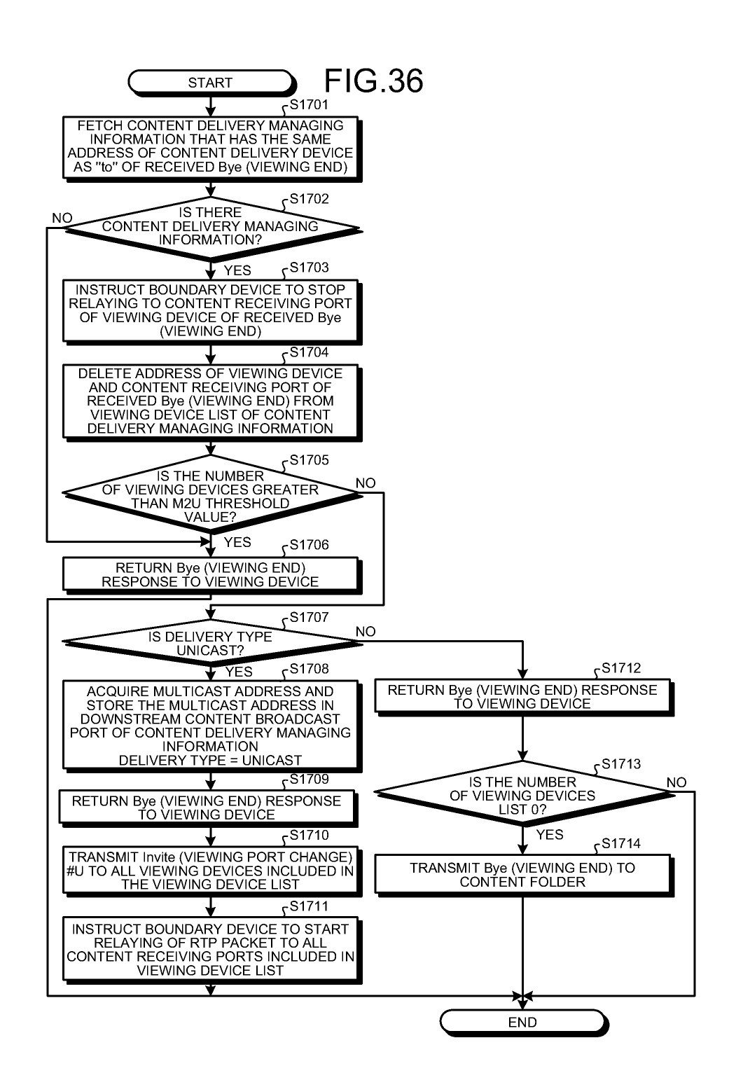

Then, when the SIP server 10B receives the viewing end and determines that the number of audiences within the multicast domain, in which connections are controlled by the SIP server 10B, is less than the threshold value, the SIP server 10B transmits a viewing port change toward all the viewing terminals that are currently in the process of viewing a content (see FIG. 36). In addition, the SIP server 10B instructs the boundary terminal 30A to start unicast delivery in step S405 and controls to perform unicast transmission in step S406.

Subsequently, when the viewing port change is received from the SIP server 10B in step S407, the viewing terminal 40A replies a response to the viewing port change in step S408 and starts to receive a content at an unicast address designated by the viewing port change in step S414.

In addition, when a viewing port change is received from the SIP server 10B in step S409, the SIP server 10C instructs a boundary device 30B to start to receive a content at an unicast address designated by the viewing port change in step S410 and returns a response to the viewing port change to the SIP server 10B in step S411.

Then, when the response to the viewing port change is received from the SIP server 10C, the SIP server 10B sequentially instructs the boundary device to stop transmission at the multicast address toward the device in step S412. Thereafter, the SIP server 10B controls the viewing terminals 40A and 40B so as to perform unicast delivery in steps S414 and S415.

Next, an operation performed in a case where the number of audiences outside a multicast domain is decreased, and switching from the multicast delivery to the unicast delivery is made will be described with reference to FIG. 29.

As illustrated in the figure, in a case where an SIP server 10A performs multicast delivery in step S501, and an SIP server 10B controls a viewing terminal 40A so as to perform unicast delivery in step S502, an SIP server 40C transmits the viewing request transmitted so as to be addressed to the content folder in accordance with the operation of an audience located outside the multicast domain to the SIP server 10B in step S503.

Then, when the SIP server 10B receives a viewing request and determines that the number of audiences is more than the threshold value, the SIP server 10B transmits a viewing port change toward all the viewing terminals that are currently in the process of viewing a content (see FIG. 33).

In addition, the SIP server 10B instructs the boundary terminal 30A to start multicast delivery in step S505 and controls the boundary terminal 30A so as to perform multicast transmission in step S506. Furthermore, the SIP server 10B returns a response to the viewing request to the SIP server 10C in step S507.

In addition, when the response to the viewing request is received from the SIP server 10B in step S507, the SIP server 10C instructs a boundary device 20B to start a relay at a multicast address designated by the response to the viewing request in step S508.

In addition, when the viewing port change is received from the SIP server 10B in step S509, the viewing terminal 40A starts to receive a content at a multicast address designated by the response to the viewing request and returns a response to the viewing port change to the SIP server 10B in step S510.

Then, when the response to the viewing port change is received from viewing terminal 40A, the SIP server 10B sequentially instructs the boundary device to stop transmission at the unicast address toward the device in step S511. Thereafter, the SIP server B controls the viewing terminals located within the multicast domain and the viewing terminals located outside the multicast terminals so as to perform multicast delivery in step S512.

Next, an operation performed in a case where the number of audiences outside a multicast domain is decreased, and switching from the multicast delivery to the unicast delivery is made will be described with reference to FIG. 30.

As illustrated in the figure, an SIP server 10A performs multicast delivery in step S601, and an SIP server 10B controls viewing terminals 40A and 40B and a boundary device 20B so as to perform multicast delivery in step S602. Then, an SIP server 10C transmits a viewing end transmitted so as to be addressed to the content folder in accordance with the operation of an audience located outside the multicast domain to the SIP server 10B in step S603.

Then, the SIP server 10B receives the viewing end and replies a response to the viewing end to the SIP server 10C in step S604. The SIP server 10C that has received the response to the viewing end instructs the boundary device 20B to stop the relay in step S605.

In addition, the SIP server 10B instructs the boundary terminal 30A to start unicast delivery in step S606. Then, when the SIP server 10B receives a viewing end and determines that the number of audiences is less than the threshold value, the SIP server 10B transmits a viewing port change toward all the viewing terminals that are currently in the process of viewing a content in step S607 and controls the viewing terminals so as to perform unicast transmission in step S608.

Subsequently, when the viewing port change is received from the SIP server 10B in step S607, the viewing terminal 40A replies a response to the viewing port change in step S609 and starts to receive a content at an unicast address designated by the viewing port change in step S612.

Then, when the response to the viewing port change is received from viewing terminal 40A, the SIP server 10B instructs the boundary device to stop transmission at the multicast address toward the device in step S610 and returns the multicast address in step S611. Thereafter, the SIP server 10B controls the viewing terminal 40A so as to perform unicast delivery in step S612.

Next, an operation performed in a case where the last audience located within the multicast domain ends viewing a content will be described with reference to FIG. 31.

As illustrated in the figure, an SIP server 10A performs multicast delivery in step S701, and an SIP server 10B controls a viewing terminal 40A so as to perform unicast delivery in step S702.

When receiving a viewing end from the viewing terminal 40A in step S703, the SIP server 10B determines that there is no audience located within the multicast domain and instructs the boundary device 20A to stop delivery of the IPTV broadcast in step S704.

Then, the SIP server 10B transmits the viewing end to the SIP server 10A in step S705. The SIP server 10A that has received the viewing end transmits a response to the viewing end to the SIP server in step S706. Then, the SIP server 10B transmits the received response to the viewing end to the audience terminal 40A in step S707. When receiving the response to the viewing end, the SIP servers 10A and 10B opens a storage area of the content delivery managing information.

Thereafter, the SIP server 10A transmits the viewing end to the key station 20. When receiving the viewing end, the key station 20 stops delivery of the IPTV broadcast and transmits the response to the viewing end to the SIP server 10A.

Next, an operation performed in a case where an audience located outside the multicast domain ends viewing will be described with reference to FIG. 32.

As illustrated in the figure, an SIP server 10A performs multicast delivery in step S801, and an SIP server 10B controls a boundary device 30B to perform unicast delivery in step S802.

When receiving a viewing end from an audience terminal located outside the multicast domain through an SIP server 10C in step S803, the SIP server 10B determines that there is no audience located within the multicast domain and instructs a boundary device 20A to stop delivery of the IPTV broadcast in step S804.

Then, the SIP server 10B transmits the viewing end to the SIP server 10A in step S805. The SIP server 10A that has received the viewing end transmits a response to the viewing end to the SIP server 10B in step S806. Then, the SIP server 10B transmits the received response to the viewing end to the audience terminals located outside the multicast domain through the SIP server 10C in step S807.

Thereafter, the SIP server 10A transmits the viewing end to the key station 20. When receiving the viewing end, the key station 20 stops delivery of the IPTV broadcast and transmits the response to the viewing end to the SIP server 10A.

Process of SIP Server

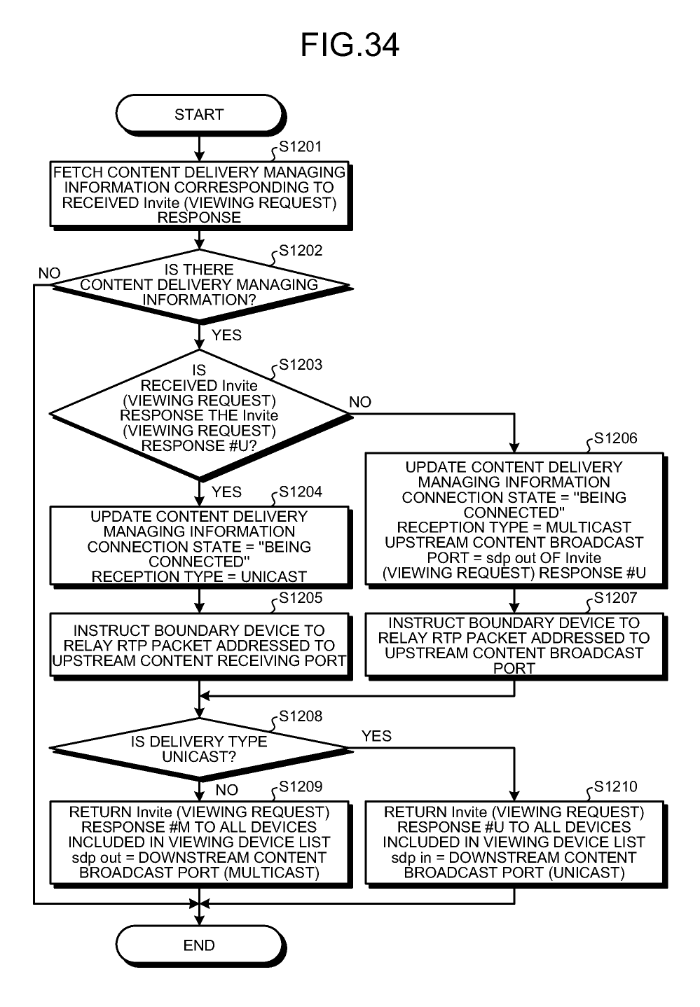

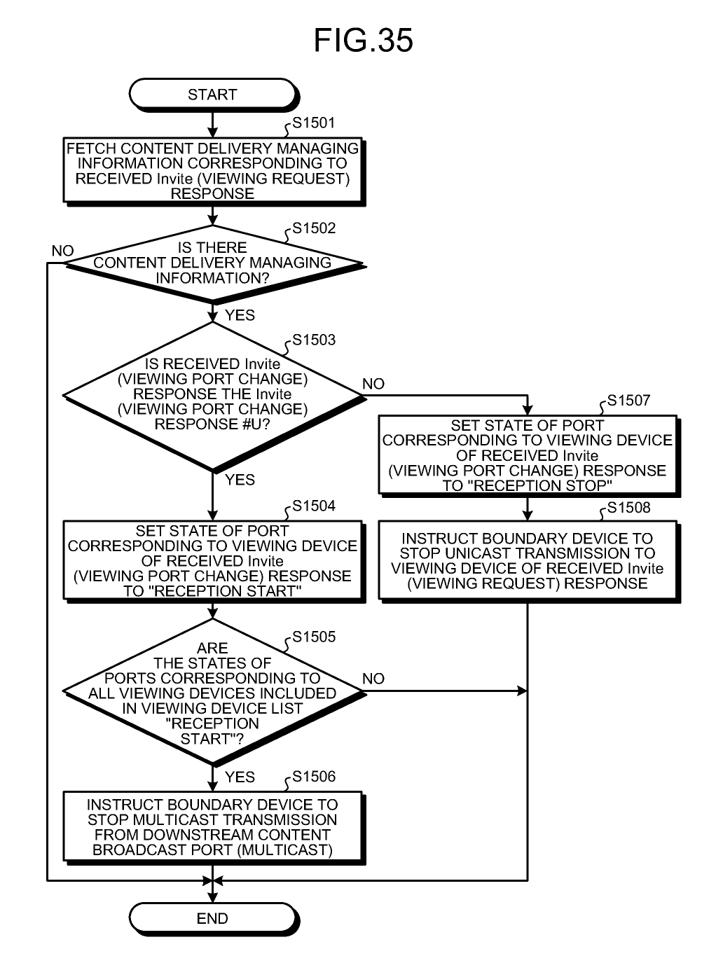

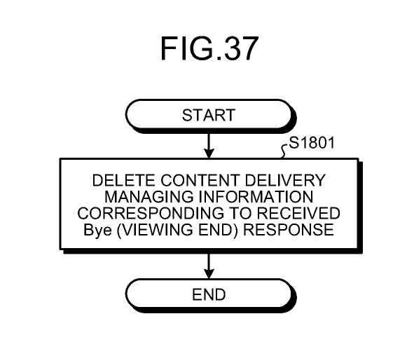

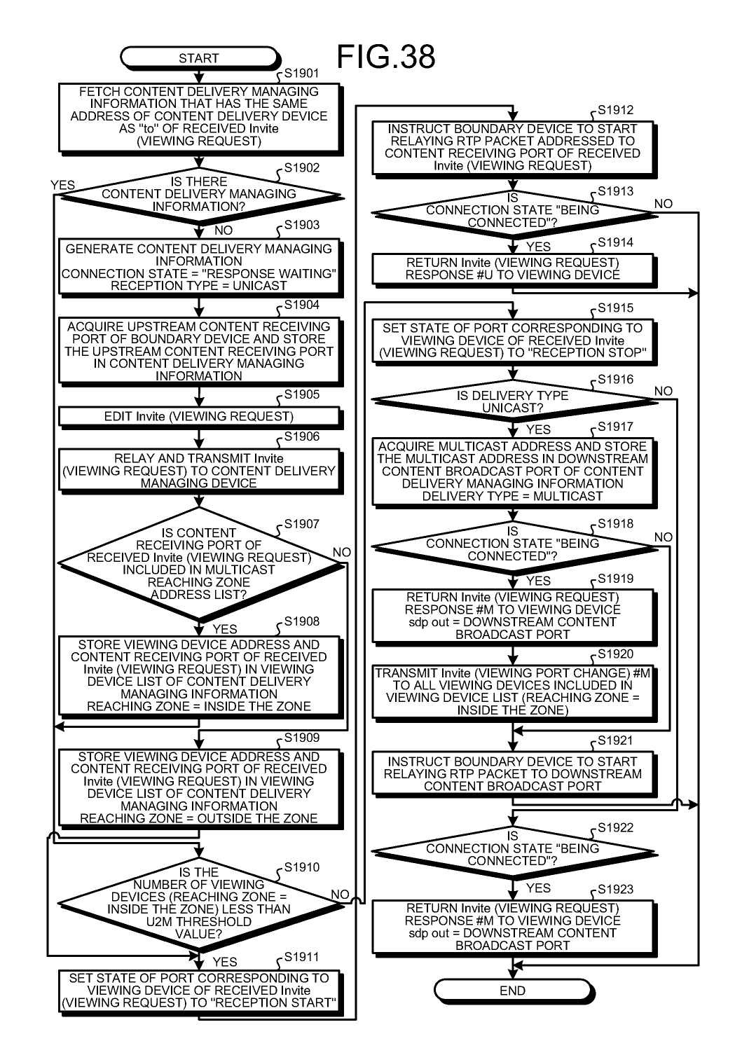

Next, the process of the SIP server 10 according to the first embodiment will be described with reference to FIGS. 33 to 41. FIG. 33 is a flowchart illustrating the operation of a relay process of a viewing request in an SIP server 10 according to the first embodiment. FIG. 34 is a flowchart illustrating the operation of a relay process of a response to a viewing request in an SIP server 10 according to the first embodiment. FIG. 35 is a flowchart illustrating the operation of a reception process of a response to a viewing port change in an SIP server 10 according to the first embodiment. FIG. 36 is a flowchart illustrating the operation of a relay process of a viewing end in an SIP server 10 according to the first embodiment. FIG. 37 is a flowchart illustrating the operation of a reception process of a viewing end in an SIP server 10 according to the first embodiment. FIG. 38 is a flowchart illustrating the operation of a relay process of a viewing request in an SIP server 10 according to the first embodiment.

First, the operation for a relay process of a viewing request in the SIP server 10 according to the first embodiment will be described with reference to FIG. 33. As illustrated in the figure, when the viewing request is received, the SIP server 10 takes out the content delivery managing information having the same address of the content delivery device (key station) 20 as “to” of the received viewing request in step S1101 and determines whether there is content delivery managing information in step S1102.

Then, in a case where there is no content delivery managing information (No in step S1102), the SIP server 10 proceeds up to step S1108. On the other hand, in a case where there is content delivery managing information (Yes in step S1102), the SIP server 10 generates content delivery managing information in step S1103, acquires an upstream content receiving port of the boundary device 30, and stores the acquired upstream content receiving port in the content delivery managing information in step S1104.

Subsequently, the SIP server 10 edits the viewing request in step S1105, relays and transmits the viewing request toward the content delivery device 20 in step S1106, and stores the address of the viewing device and the content receiving port of the received viewing request in the viewing device list of the content delivery managing information in step S1107.

Then, the SIP server 10 determines whether the number of viewing devices is less than the U2M threshold value in step S1108. As a result, when the number of the viewing devices is less than the U2M threshold value (Yes in step S1108), the SIP server 10 sets the state of the port corresponding to the viewing device of the received viewing request to “reception start” in step S1109.

Then, the SIP server 10 instructs the boundary device 30 to start the relay of an RTP packet to the content receiving port of the received viewing request in step S1110 and determines whether or not the connection state is “being connected” in step S1111.

As a result, in a case where the connection state is “being connected” (Yes in step S1111), the SIP server 10 replies a response to the viewing request to the viewing device 40 in step S1112. On the other hand, in a case where the connection state is not “being connected” (No in step S1111), the SIP server 10 ends the process.

Returning to the description of step S1108, in a case where the number of viewing devices is the U2M threshold value or more (No in step S1108), the SIP server 10 sets the state of the port corresponding to the viewing device of the received viewing request to “reception stop” in step S1113 and determines whether the delivery type is “unicast” in step S1114.

As a result, in a case where the delivery type is “unicast” (Yes in step S1114), the SIP server 10 acquires a multicast address, stores the multicast address in the downstream content broadcast port of the content delivery managing information in step S1115, and determines whether or not the connection state is “being connected” in step S1116.

As a result, in a case where the connection state is “response waiting” (No in step S1116), the SIP server 10 instructs the boundary device 30 to start the relay of the RTP packet to the broadcast port of the downstream broadcast content in step S1119.

On the other hand, in a case where the connection state is “being connected” (Yes in step S1116), the SIP server 10 returns a response to the viewing request to the viewing device 40 in step S1117, transmits a viewing port change to all the viewing devices 40 included in the viewing device list in step S1118, and instructs the boundary device 30 to start the relay of the RTP packet to the broadcast port of the downstream broadcast content in step S1119.

Returning to the description of step S1114, in a case where the delivery type is “multicast” (No in step S1114), the SIP server 10 determines whether or not the connection state is “being connected” in step S1120. As a result, in a case where the connection state is “being connected” (Yes in step S1120), the SIP server 10 returns a response to the viewing request to the viewing device 40 in step S1121. In addition, in a case where the connection state is “response waiting” (No in step S1120), the SIP server 10 ends the process.

Subsequently, FIG. 34 is a flowchart illustrating the operation of a relay process of a response to a viewing request in the SIP server 10 according to the first embodiment. As illustrated in the figure, when a response to a viewing request is received, the SIP server 10 takes out the content delivery managing information of the received response to the viewing request in step S1201 and determines whether or not there is content delivery managing information in step S1202. As a result, in a case where there is no content delivery managing information (No in step S1202), the SIP server 10 ends the process.

On the other hand, in a case where there is content delivery managing information (Yes in step S1202), the SIP server 10 determines whether or not the received response to a viewing request is a response (hereinafter, referred to as a response #U to a viewing request) indicating that a content is received at an unicast address in step S1203.

As a result, in a case where the received response to a viewing request is the response #U to a viewing request (Yes in step S1203), the SIP server 10 updates the content delivery managing information to unicast in step S1204 and instructs the boundary device 30 to relay an RTP packet addressed to the upstream content receiving port in step S1205.

On the other hand, in a case where the received response to a viewing request is not the response #U to a viewing request (No in step S1203), the SIP server 10 updates the content delivery managing information to multicast in step S1207 and instructs the boundary device 30 to relay the RTP packet addressed to the upstream content receiving port in step S1208.

Then, the SIP server 10 determines whether or not the delivery type is “unicast” in step S1209. In a case where the delivery type is “unicast” (Yes in step S1209), the SIP server 10 returns the response #U to a viewing request to all the devices included in the viewing device list in step S1211.

On the other hand, in a case where the delivery type is “multicast” (No in step S1209), the SIP server 10 returns a response (hereinafter referred to as a viewing request #M) to a viewing request that indicates that a content is received at a multicast address to all the devices included in the viewing device list in step S1210.

Subsequently, FIG. 35 is a flowchart illustrating the operation of a reception process of a response to a viewing port change in the SIP server 10 according to the first embodiment. As illustrated in the figure, when a response to a viewing port change is received, the SIP server 10 takes out the content delivery managing information of the received response to the viewing port change in step S1501 and determines whether or not there is content delivery managing information in step S1502. As a result, in a case where there is no content delivery managing information (No in step S1502), the SIP server 10 ends the process.

On the other hand, in a case where there is content delivery managing information (Yes in step S1502), the SIP server 10 determines whether or not the received response to a viewing port change is a response (hereinafter, referred to as a response #U to a viewing port change) for switching to receive a content at an unicast address in step S1503.

As a result, in a case where the received response to a viewing port change is the response #U to a viewing port change (Yes in step S1503), the SIP server 10 sets the state of the port corresponding to the viewing device of the received response to a viewing port change to “reception start” in step S1504 and determines whether ports corresponding to all the viewing devices included in the viewing device list start to receive a content in step S1505.

As a result, in a case where the ports corresponding to all the viewing devices included in the viewing device list have started to receive contents (Yes in step S1505), the SIP server 10 instructs the boundary device 30 to stop multicast transmission at the downstream content broadcast port (multicast) in step S1506. On the other hand, in a case where the ports corresponding to all the viewing devices included in the viewing device list have not started to receive contents (No in step S1505), the SIP server 10 ends the process.

On the other hand, in a case where the received response to a viewing port change is not the response #U to a viewing port change (No in step S1503), the SIP server 10 sets the state of the port corresponding to the viewing device of the received response to a viewing port change to “reception stop” in step S1507 and instructs the boundary device 30 to stop unicast transmission to the viewing device of the received response to the viewing request in step S1508.

Subsequently, FIG. 36 is a flowchart illustrating the operation of a relay process of a viewing end in the SIP server 10 according to the first embodiment. As illustrated in the figure, when a viewing end is received, the SIP server 10 takes out the content delivery managing information having the same address of the content delivery device as the “to” of the received viewing end in step S1701 and determines whether there is content delivery managing information in step S1702.

In a case where there is no content delivery managing information (No in step S1702), the SIP server 10 returns a response to the viewing end to the viewing device 40 in step S1706 and ends the process.

On the other hand, in a case where there is content delivery managing information (Yes in step S1702), the SIP server 10 instructs the boundary device 30 to stop the relay addressed to the content receiving port of the viewing device 40 of the received viewing end in step S1703 and deletes the address and the content receiving port of the viewing device that has ended the viewing of a content from the viewing device list of the content delivery managing information in step S1704.

Then, the SIP server 10 determines whether or not the number of the viewing devices is more than the M2U threshold value in step S1705. In a case where the number of the viewing devices is more than the M2U threshold value (Yes in step S1705), the SIP server 10 returns a response to the viewing end to the viewing device 40 in step S1706 and ends the process.

On the other hand, in a case where the number of the viewing devices is less than the M2U threshold value (No in step S1705), the SIP server 10 determines whether the delivery type is “unicast” in step S1707. As a result, in a case where the delivery type is “multicast” (No in step S1707), the SIP server 10 acquires a multicast address, stores the multicast address in the downstream content broadcast port of the content delivery managing information in step S1708, and returns a response to the viewing end to the viewing device 40 in step S1709.

Then, the SIP server 10 transmits a viewing port change #U to all the viewing devices 40 included in the viewing device list in step S1710 and instructs the boundary device 30 to start the relay of an RTP packet addressed to all the content receiving ports to the viewing device list in step S1711.

On the other hand, in a case where the delivery type is “unicast” (Yes in step S1707), the SIP server 10 returns a response to the viewing end to the viewing device 40 in step S1712 and determines whether the viewing device list is “0” in step S1713. Then, in a case where the viewing device list is “0” (Yes in step S1713), the SIP server 10 transmits a viewing end to the content folder in step S1714. On the other hand, in a case where the viewing device list is not “0” (No in step S1713), the SIP server 10 ends the process.

Subsequently, FIG. 37 is a flowchart illustrating the operation of a reception process of a viewing end in the SIP server 10 according to the first embodiment. As illustrated in the figure, when a response to a viewing end is received, the SIP server 10 deletes the content delivery managing information corresponding to the response to the viewing end in step S1801.

Subsequently, FIG. 38 is the operation of a relay process of a viewing request in the SIP server 10 according to the first embodiment and illustrates an example in which there is a direct relay destination that a multicast packet from the multicast domain, in which the viewing connections are supervised by the SIP server, does not reach (in other words, an example that is applied to a case where there is a connection between multicast domain connections in the form illustrated in FIG. 23 as an example). As illustrated in the figure, the SIP server 10, similarly to the relay process of a viewing request illustrated in FIG. 33, relays and transmits a viewing request toward the content delivery device in step S1906 and then, determines whether or not the content receiving port of the received viewing request is included in the multicast reaching zone address list in step S1907.

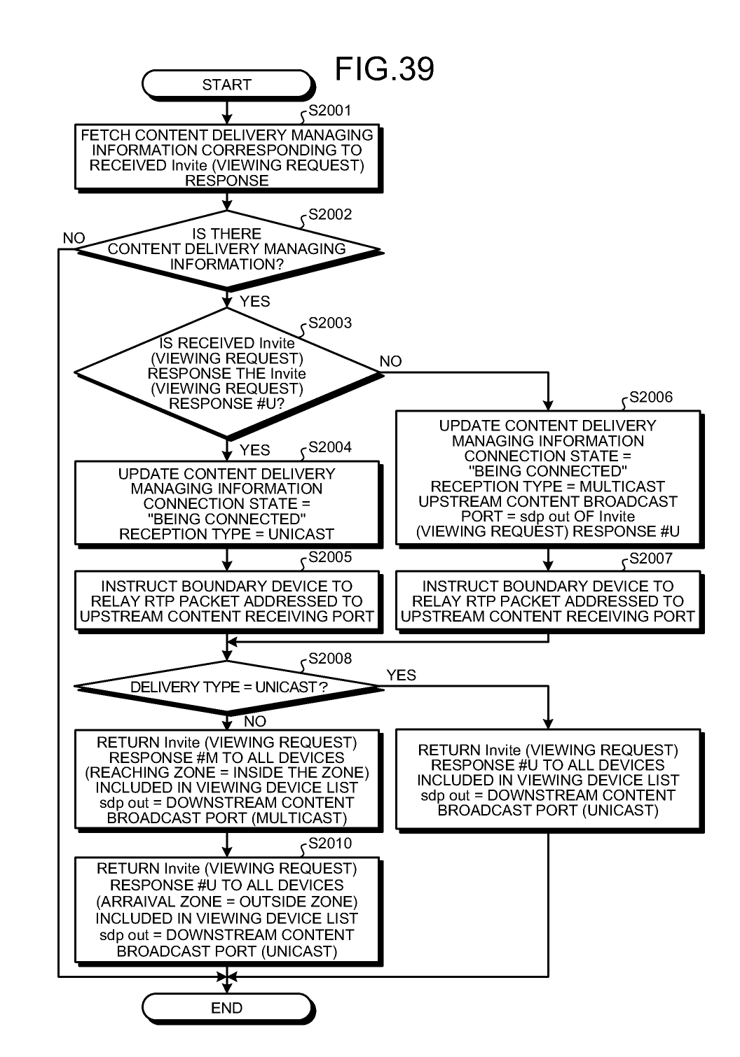

Subsequently, FIG. 39 is the operation of a relay process of a response to a viewing request in the SIP server 10 according to the first embodiment and illustrates an example in which there is a direct relay destination that a multicast packet from the multicast domain, in which the viewing connections are supervised by the SIP server, does not reach (in other words, an example that is applied to a case where there is a connection between multicast domain connections in the form illustrated in FIG. 23 as an example). As illustrated in the figure, when a response to a viewing request is received, the SIP server 10, similarly to the relay process of the response to a viewing request illustrated in FIG. 34, determines whether the delivery type is “unicast” in step S2008.

As a result, in a case where the delivery type is “multicast” (No in step S2008), the SIP server 10 replies with a response #M to a viewing request to all the devices, which are included in the viewing device list, having “arrival zone=inside of the zone” so as to receive a content in the multicast mode in step S2009.

Then, the SIP server 10 returns the response #M to a viewing request to all the devices, which are included in the viewing device list, having “arrival zone=outside of the zone” so as to receive contents in the unicast mode in step S2010.

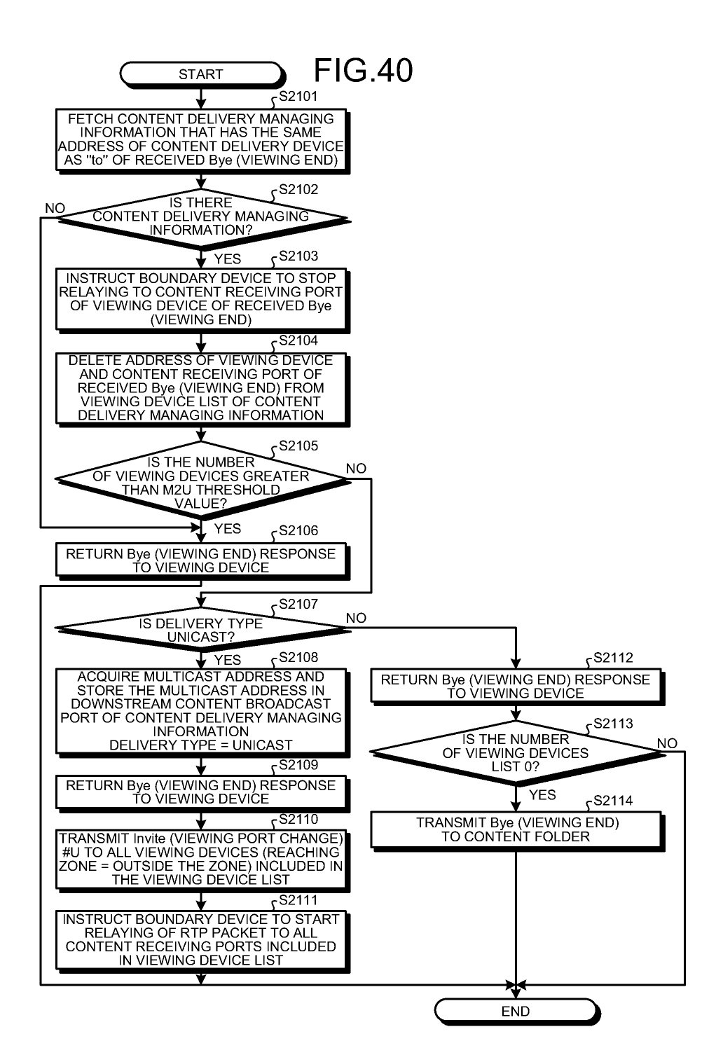

Subsequently, FIG. 40 is the operation of a relay process of a viewing end in the SIP server 10 according to the first embodiment and illustrates an example in which there is a direct relay destination that a multicast packet from the multicast domain, in which the viewing connections are supervised by the SIP server, does not reach (in other words, an example that is applied to a case where there is a connection between multicast domain connections in the form illustrated in FIG. 23 as an example). As illustrated in the figure, when a viewing end is received, the SIP server 10, similarly to the relay process of the viewing end illustrated in FIG. 36, returns a response to a viewing end to the viewing device 40 in step S2108 and then, transmits a viewing port change #U to all the viewing devices 40, which are included in the connection device list, having “the arrival zone=outside of the zone” in step S2109.

Subsequently, FIG. 39 is an example of the operation of a reception process of a viewing port change in the SIP server 10 according to the first embodiment. As illustrated in the figure, when a viewing port change is received, the SIP server 10 takes out the content delivery managing information corresponding to the received viewing port change in step S2201 and determines whether or not there is content delivery managing information in step S2202.

In a case where there is no content delivery managing information (No in step S2202), the SIP server 10 ends the process. On the other hand, in a case where there is content managing information (Yes in step S2202), the SIP server 10 determines whether or not the received viewing port change is the viewing port change #U in step S2203.

As a result, when the received viewing port change is the viewing port change #U (Yes in step S2203), the SIP server 10 updates the reception type of the content delivery managing information to “unicast” in step S2204. Then, the SIP server 10 instructs the boundary device 30 to relay an upstream content receiving port RTP packet in step S2205 and returns the response #U to the viewing port change in step S2206.

In addition, in a case where the received viewing port change is not the viewing port change #U (No in step S2203), the SIP server 10 updates the reception type of the content delivery managing information to “multicast” in step S2207. Then, the SIP server 10 instructs the boundary device 30 to relay an upstream content receiving port RTP packet in step S2208 and returns a response #M to the viewing port change in step S2209.

Process of Viewing Device

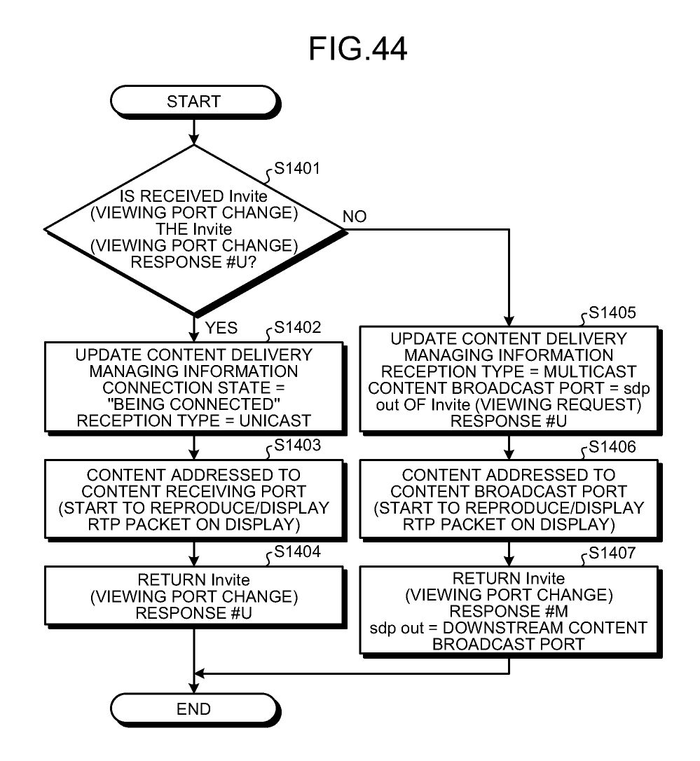

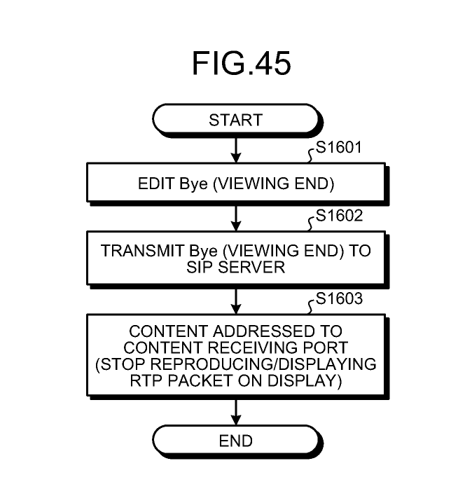

Next, the process of the viewing device 40 according to the first embodiment will be described with reference to FIGS. 42 to 45. FIG. 42 is a flowchart illustrating the operation of a transmission process of a viewing start request in the viewing device 40 according to the first embodiment. FIG. 43 is a flowchart illustrating the operation of a reception process of a response to a viewing request in the viewing device 40 according to the first embodiment. FIG. 44 is a flowchart illustrating the operation of a reception process of a viewing port change in the viewing device 40 according to the first embodiment. FIG. 45 is a flowchart illustrating the operation of a relay process of a viewing end in the viewing device 40 according to the first embodiment.

First, the operation of a viewing start request transmitting process in the viewing device 40 according to the first embodiment will be described with reference to FIG. 42. As illustrated in the figure, when an audience performs a start operation, the viewing device 40 edits a viewing request in step S1001 and transmits the viewing request to the SIP server 10 in step S1002. Then, the viewing device 40 starts to reproduce/display contents addressed to the content (the RTP packet) receiving port on the display in step S1003.

Next, the operation of a reception process of a response to a viewing request in the viewing device 40 according to the first embodiment will be described with reference to FIG. 43. As illustrated in the figure, when a response to a viewing request is received, the viewing device 40 determines whether the received response to the viewing request is the response #U to a viewing request in step S1301.

As a result, in a case where the received response to the viewing request is the response #U to the viewing request (Yes in step S1301), the viewing device 40 updates the reception type of the content delivery managing information to “unicast” in step S1302 and reproduces/displays the content addressed to the content receiving port on the display in step S1303.

On the other hand, in a case where the received response to the viewing request is the response #M to the viewing request (No in step S1301), the viewing device 40 updates the reception type of the content receiving information to “multicast” in step S1304 and reproduces/displays the content addressed to the content broadcast port on the display in step S1305.

The operation of a reception process of a viewing port change in the viewing device 40 according to the first embodiment will be described with reference to FIG. 44. As illustrated in the figure, when a viewing port change is received, the viewing device 40 determines whether or not the received viewing port change is the viewing port change #U in step S1401.

As a result, in a case where the received viewing port change is the viewing port change #U (Yes in step S1401), the viewing device 40 updates the information type of the content delivery managing information to “unicast” in step S1402. Then, the viewing device 40 starts to reproduce/display contents addressed to the content receiving port on the display in step S1403 and sends the response to the viewing port change back in step S1404.

On the other hand, in a case where the received viewing port change is not the viewing port change #U (No in step S1401), the viewing device 40 updates the information type of the content receiving information to “multicast mode” in step S1405. Then, the viewing device 40 starts to reproduce/displays contents addressed to the content receiving port on the display in step S1406 and sends the response #M to the viewing port change back in step S1407.

Next, the operation of a relay process of a viewing end in the viewing device 40 according to the first embodiment will be described with reference to FIG. 45. As illustrated in the figure, when an audience performs an operation of stopping the viewing, the viewing device 40 edits the viewing end in step S1601.

Then, the viewing device 40 transmits a viewing end to the SIP server 10 in step S1602 and stops the reproduction/display of the content addressed to the content receiving port in step S1603.

### Advantages of First Embodiment

As described above, the SIP server 10 determines whether or not the number of delivery requests used for requesting content delivery from a terminal in a delivery zone is a predetermined threshold value or more. The SIP server 10 controls so as to transmit a content through multicast in a case where the number of the delivery requests is determined to be the predetermined threshold value or more and controls so as to transmit a content through unicast in a case where the number of the delivery requests is determined to be less than the predetermined threshold value. Accordingly, the occupation of unnecessary packets in a communication band is prevented, and whereby the quality of the communication service can be improved.

In addition, according to the first embodiment, in a case where delivery information is transmitted to an area other than the delivery zone, unicast transmission is controlled to be performed. Accordingly, the occupation of unnecessary packets in a communication band outside the delivery zone is prevented, and whereby the quality of the communication service can be improved.

### [b] Second Embodiment

Although an embodiment has been described until now, the embodiment may be performed in various forms other than the above-described embodiment. Thus, hereinafter, another embodiment belonging to the scope of the invention will be described as a second embodiment.

(1) System Configuration and the Like

Each constituent element of each device illustrated in the figures is in a functional or conceptual sense and does not need to be configured physically as illustrated. In other words, a concrete form of separation or integration of the devices is not limited to that illustrated in the figures. Thus, the whole or a part thereof may be functionally or physically divided or integrated in arbitrary units in accordance with various loads or the use situations. For example, the audience number determining unit 12a and the transmission control unit 12b may be integrated together. Furthermore, the whole or a part of each process function performed by each device may be realized by a CPU or a program that is interpreted and executed by the CPU or may be realized by hardware using wired logic.

In addition, the whole or a part of each process that has been described as being automatically performed out of the processes described in this embodiment may be manually performed, or the whole or a part of the process described as being manually performed in this embodiment may be automatically performed by using a known method. Furthermore, the process sequence, the control sequence, a concrete name, information including various types of data and parameters represented in the description and diagrams presented here may be arbitrarily changed unless otherwise mentioned.

(2) Program

The content delivery method described in this embodiment may be realized by executing a program prepared in advance by using a computer such as a personal computer or a workstation. This program may be distributed through a network such as the Internet. Furthermore, this program may be recorded in a computer-readable recording medium such as a hard disk, a flexible disk (FD), a CD-ROM, an MO, or a DVD and can be executed by being read out from the recording medium by a computer.

The disclosed system can improve the quality of the communication service by preventing unnecessary packets from occupying the communication band.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A delivery system comprising:
a delivery server that delivers delivery information to a delivery zone to which terminals belongs;
a relay server that relays the delivery information between the delivery zones; and
an agent server that controls the relay server so as to perform a relay operation between the delivery zones,
wherein the agent server includes
an audience number determining unit that determines whether or not the number of delivery requests, which are used to request for delivery, from the terminals located within the delivery zone is a predetermined threshold value or more; and
a transmission control unit that controls the delivery server and/or the relay server so as to perform multicast transmission in a case where the number of the delivery requests is determined to be the predetermined threshold value or more by the audience number determining unit and controls the delivery server and/or the relay server so as to perform unicast transmission in a case where the number of the delivery requests is determined to be less than the predetermined threshold value by the audience number determining unit.

2. The delivery system according to claim 1, wherein the transmission control unit controls the delivery server and/or the relay server so as to perform unicast transmission in a case where the delivery information is transmitted outside the deliver zone.

3. An agent server comprising:
an audience number determining unit that determines whether or not the number of delivery requests, which are used to request for delivery, from terminals located within a delivery zone is a predetermined threshold value or more; and
a transmission control unit that controls so as to perform multicast transmission in a case where the number of the delivery requests is determined to be a predetermined threshold value or more by the audience number determining unit and controls to perform unicast transmission in a case where the number of the delivery requests is determined to be less than the predetermined threshold value by the audience number determining unit.

4. The agent server according to claim 3, wherein the transmission control unit is controlled so as to perform unicast transmission in a case where the delivery information is transmitted outside the delivery zone.

5. A delivery method comprising:
determining whether or not the number of delivery requests, which are used to request for delivery, from terminals located within a delivery zone is a predetermined threshold value or more; and
controlling so as to perform multicast transmission in a case where the number of the delivery requests is determined to be a predetermined threshold value or more at the determining and controlling to perform unicast transmission in a case where the number of the delivery requests is determined to be less than the predetermined threshold value at the determining.

6. The delivery method according to claim 5, wherein the controlling includes controlling such that unicast transmission is performed in a case where the delivery information is transmitted outside the delivery zone.
